(19) United States
(12) Patent Application Publication
(10) Pub. No.: US 2021/0342866 A1
(43) Pub. Date: Nov. 4, 2021

(54) SELECTING TARGET AUDIENCES FOR MARKETING CAMPAIGNS

(71) Applicant: Adobe Inc., San Jose, CA (US)

(72) Inventors: Camille Girabawe, Santa Clara, CA (US); Richard Yang, Foster City, CA (US); Goutham Srivatsav Arra, San Mateo, CA (US); Akangsha Sunil Bedmutha, San Mateo, CA (US); Omar Rahman, San Jose, CA (US); Niranjan Kumbi, Fremont, CA (US); Vaidyanathan Venkatraman, Fremont, CA (US)

(73) Assignee: Adobe Inc., San Jose, CA (US)

(21) Appl. No.: 16/861,756

(22) Filed: Apr. 29, 2020

(51) Int. Cl. G06Q 30/02; G06F 16/28; G06F 16/901; G06F 16/9535

(52) U.S. Cl. CPC G06Q 30/0205; G06Q 30/0242; G06F 16/9535; G06F 16/9024; G06F 16/285

(57) ABSTRACT

Techniques are disclosed for selecting audience members for a marketing campaign. A list of potential members is accessed, where each member is associated with a corresponding feature vector comprising features. A subset of the features is selected, and used to select a first group from the list for inclusion in the campaign, thereby also defining a second group from the list for exclusion from the campaign. A first similarity among the members in the first group is compared to a second similarity between the members in the first and second groups. If the first similarity is equal to or lower than the second similarity, the subset of features is updated to form a new subset of features, and the selection process of target audience member is repeated, until the first similarity becomes higher than the second similarity. Subsequently, the marketing campaign is launched with the first group of members.

### FIELD OF THE DISCLOSURE

This disclosure relates generally to audience selection, and more specifically to selecting target audiences for a marketing campaign.

### BACKGROUND

Businesses use a variety of marketing tactics in order to move a prospective customer through the marketing funnel. For example, the customer initially becomes aware of a product, shows interest in the product, considers and evaluates the product, and finally purchases the product. Thus, a typical customer may move through various stages or phases, such as awareness of the product, interest in the product, consideration and evaluation of the product, and/or purchase of the product. In any such cases, marketing programs or campaigns can be employed to influence prospective customers, and to move a customer closer to a purchase. Examples of such marketing campaigns include emailing and/or sending physical letters to potential customers about a product or service, organizing physical campaign events, webinars, and/or otherwise engagement with potential customers.

An aspect of a marketing campaign is to select target audience members for the campaign. For example, if all potential audience members are targeted during each and every marketing campaign launched by a marketer, the audience members may develop fatigue from being exposed to too many such marketing campaigns, which in turn may cause audience members to ignore such campaigns. Thus, a more restrained and selective process is called for. Unfortunately, judiciously filtering and selecting audience members for a specific marketing campaign is a non-trivial task, and the success of the marketing campaign depends at least in part on the effectiveness of the selection process.

### BRIEF DESCRIPTION OF THE DRAWINGS

FIG. 1 is a block diagram schematically illustrating selected components of an example computing device configured to select target audience members for a marketing campaign, in accordance with some embodiments of the present disclosure.

FIG. 2 is a block diagram schematically illustrating selected components of an example system comprising the computing device of FIG. 1 communicating with server device(s), where the combination of the computing device and the server device(s) are configured to select target audience members for a marketing campaign, in accordance with some embodiments.

FIG. 3A is a flowchart illustrating an example method for selecting target audience members for a marketing campaign, in accordance with some embodiments of the present disclosure.

FIG. 3A1 is a flowchart illustrating an example method to determine if a hypothesis H1 of the method of FIG. 3A is validated, in accordance with some embodiments of the present disclosure.

FIG. 3B is a flowchart illustrating an example method for expanding a previous selection of target audience members for a marketing campaign, in accordance with some embodiments of the present disclosure.

FIGS. 4A-4F illustrate various example scenarios associated with selecting target audience members for a marketing campaign, in accordance with some embodiments of the present disclosure.

FIG. 5 schematically illustrates example groups of targeted and non-targeted audience members of a marketing campaign, in accordance with some embodiments of the present disclosure.

### DETAILED DESCRIPTION

Techniques are disclosed for selecting audience members from a list L of potential audience members, where the selected audience members are targeted during a marketing campaign. In addition to being selected based on their own attributes or features, each audience member is further selected based on context of the marketing campaign. In more detail, and according to some embodiments of the present disclosure, each audience member in the list L is associated with a feature vector comprising a plurality of features, where features can include demographic features, behavioral features, and/or firmographic features. A subset of the features is initially selected, and a first group of audience members is selected based on the subset of features, thereby also defining a second group of non-selected audience members. Subsequently, it is determined whether the selected audience members among the first group are significantly similar enough, e.g., compared to a similarity between audience members between the first and second groups. If the selected audience members among the first group are not similar enough (relative to the similarity between audience members between the first and second groups), this implies that the initially selected audience members within the first group are not sufficiently optimal. In such a scenario, the selection of the subset of features is refined or otherwise modified and the process is iteratively repeated, until the first group of selected audience members have sufficient similarity among each other, relative to the similarity between audience members between the first and second groups. Once a preestablished level of similarity is achieved among the first group of selected audience members, relative to the similarity between audience members between the first and second groups, that first group of selected audience members is then considered sufficiently optimal and the marketing campaign can be launched targeting audience members of that first group. In some embodiments, the first group of selected audience members can be opportunistically expanded, to include audience members of the non-selected second group. For example, in some such embodiments, based on further information gained from a marketing campaign that has been initiated, one or more audience members are moved from the non-selected second group to the selected first group. In one such embodiment, the further information includes comparison of statistical similarity to a first group of members who respond positively to the campaign, to statistical similarity with a second group that includes members who did not respond positively to the campaign. Then the marketing campaign can also target the newly added audience members of the first group. Numerous embodiments and variations will be apparent in light of this disclosure.

General Overview

As previously noted, selecting audience members from a large list of potential audience members for a marketing campaign is a non-trivial task, and the success of the marketing campaign depends at least in part on the effectiveness of the selection process. Prior selection processes allow a marketer to identify potential audiences based on known propensities of the individual audience members, such as propensity to purchase, or propensity to click a marketing email. This enables the marketer to filter out those audience who have lower propensities for success, and allows the marketer to possibly identify potential successful audience members for the campaign. However, such an audience selection process is built on top of a set of a marketer's selected attributes, without considering the overall contextual nature of the marketing campaign.

To this end, techniques are disclosed herein for enhancing the selection process of a group of audience members to be targeted in a marketing campaign. According to some embodiments, this enhancement is accomplished by comparison of statistical similarity among a first group of audience members whom were invited to the campaign, to statistical similarity between that first group and a second group that includes members whom were not invited to the campaign. The criteria (member features or attributes) for selecting the first group of invited audience members can then be refined until the comparison satisfies a given threshold. The campaign can then be launched using the refined first group. Further enhancement to the first group of invited audience members may include comparison of statistical similarity among a first subset of invited members whom respond positively to the campaign, to statistical similarity between that first subset and a second subset that includes members whom do not respond positively to the campaign. One or more uninvited members from the second group can be added to the first group until this second comparison satisfies a given threshold. The campaign can then be continued or re-launched using the refined first group.

For the purpose of this disclosure, a marketer is referred to as one or more persons and/or organizations who are responsible for selecting target audience members for a marketing campaign, and/or running the campaign. The marketer utilizes various tools, apparatus, and/or methods discussed herein to intelligently select target audience members for the marketing campaign, so as to increase a chance of a higher percentage of the selected audience members responding positively to the marketing campaign.

A marketing campaign is a collection of events or operations, through which the marketer advertises or markets a product or a service. For example, a marketer can conduct a marketing campaign to launch a new product, such as a new cell phone, a new beauty product, or a new line of clothes. In another example, marketer can conduct a marketing campaign to advertise services provided by a website, by a hospital, by an engineering firm, or by a house cleaning service. Other examples of marketing campaigns include any type of appropriate marketing campaign envisioned by those skilled in the art, in which the marketer selects target audience members from a larger pool of potential audience members.

The marketer conducts the marketing campaign by approaching and/or engaging the selected target audience members via any appropriate medium, such as email, physical letters, brochures or pamphlets, by calling the audience members over phone, by displaying notification via an installed application in mobile phones of the selected audience members, by visiting houses and/or offices of the selected audience members, setting up exhibition or booths in selected geographical locations or conferences, advertising in selected print and/or electronic media, conducting advertisements that are specifically targeted for the selected audience members, and/or otherwise approaching the selected audience members.

As will be appreciated, the techniques provided herein can be implemented in a number of ways. In some example embodiments of the present disclosure, the selection of the target audience is at least in part implemented by a target audience selection system of a computing device and/or a sever. In an example, the target audience selection system accesses a list L of potential audience member population. In a practical marketing campaign, the list L of potential audience members is likely to include hundreds, thousands, tens or hundreds of thousands, or higher number of potential audience members, depending on the quantum of audience outreach the marketer wants to achieve. For example, for a local marketing campaign, the marketer can generate the list L of people residing in a given neighborhood (e.g., list of people residing in a zip code where the campaign is taking place, as well as people residing in one or more adjacent zip codes). In contrast, for a nationwide product launch, the list L is likely to include a relatively larger number of audience spread throughout the nation. The list L is usually available to the marketer who is launching the marketing campaign. The list L can include audience members who may possibly be interested in the marketing campaign, and can also possibly include audience members who may not be interested in the marketing campaign, as will be discussed in turn. The target audience member for the marketing campaign is selected from this list L.

In some embodiments, the target audience selection module assigns, to each member in the list L, a corresponding feature vector. As discussed, a feature vector includes corresponding values of N features, where N is a positive integer. A feature vector (FV) includes a plurality of features fa, fb, fc, . . . , fN, i.e., includes N features.

A feature is representative of an attribute or characteristic associated with the audience members. In some embodiments, features comprise demographic features, behavioral features, and/or firmographic features. Examples of demographic features include a person's age, gender, educational qualification, number of children in the household, address, and/or other attributes that are associated with the person's demography. Examples of firmographic features include income level, job title, the person's workplace details (e.g., private organization, government organization, self-employed), one or more attributes that are associated with the workplace, firm, or organization in which the audience works, and/or other job-related details. In an example, behavioral features include characteristics or attributes associated with the person's behavior, such as hobbies, whether the household has a game console, whether the person plays video games, historical interactions with other products affiliated with the marketed product, and/or other behavioral attributes.

For a specific audience, each feature is assigned a corresponding measurable feature value. For example, for a feature comprising address of an audience member, the assigned feature value can be the zip code. In another example, for a feature comprising job title of an audience member, the assigned feature value can be 1 for legal job, 2 for job in the health care sector, 3 for job in an engineering firm, and so on. In yet another example, for a feature comprising gender, the assigned feature value can be 1 for male, 2 for female, or 3 for undisclosed or unknown gender.

As discussed, a feature vector associated with an audience has values for features fa, fb, . . . , fN. Thus, there can be N number of features in a feature vector, where N is an integer. The feature vector is defined within an N-dimensional plane. Each audience member has a respective coordinate in the N-dimensional plane, where the coordinate is defined by the corresponding feature vector. A similarity graph can be generated for the audience members included in the list L, where a distance between two audience members in the similarity graph can be representative of a Euclidean distance between the feature vectors in the N dimensional plane assigned to the two audience members. Any appropriate similarity graphing algorithm can be employed for generating the similarity graph, such as K-Nearest Neighbor (K-NN) graph algorithm, ANNOY (Approximate Nearest Neighbors Oh Yeah), or another appropriate similarity graphing algorithm. Thus, a distance between two audience members in the similarity graph is indicative of a Euclidian distance between the feature vectors of the two audiences. In an example, the similarity graphing is also referred to as a model, and is generated by a model generation module of the target audience section system.

Thus, in the similarity graph or model comprising the audience members of the list L, Euclidian distance between any pair of audience members can be calculated. The Euclidian distance between the feature vectors of two audience members (also referred to as Euclidian distance between two audience members, or simply as distance between two audience members) is representative of how similar the two audience members are, based on the feature values associated with the two audience members. Accordingly, the Euclidian distance between any two audience members is also associated with a “similarity strength” or “similarity value” between the two audience members. For example, a relatively low Euclidian distance between any two audience members implies that the two audience members are relatively more similar —accordingly, the similarity strength or similarity value between the two audience members is relatively high. On the other hand, a relatively high Euclidian distance between any two audience members implies that the two audience members are relatively less similar—accordingly, the similarity strength or similarity value between the two audience members is relatively low. Thus, the Euclidian distance between two audience members are inversely related to (e.g., inversely proportional to) the similarity strength or similarity value between the two audience members. If the similarity strength between two audience members is relatively high (e.g., higher than a threshold), this implies that the two audience members are “look alike” audiences.

In some embodiments, the target audience selection system initially selects a subset of the N features of the feature vectors, and the model generation module generates a similarity model or similarity graph based on the selected subset of N features. Merely as an example, assume that N=50, i.e., there are 50 different features within each feature vector FV, such as demographic, firmographic and/or behavioral features discussed herein. Of those 50 features, merely as an example, 5 features can be selected initially. For example, assume that there are features {fa, fb, . . . , fN} features, and the selected subset N1 can be {fa, fc, fd, fe, fg}. This results in truncated feature vectors that includes only the selected subset of features. For example, for an audience member M1 in the list L, the truncated feature vector will be [fa1, fc1, fd1, fe1, fg1]; for member M2, the truncated feature vector will be [fa2, fc2, fd2, fe2, fg2], and so on. The model generation module generates the model of the similarity graph based on the selected features {fa, fc, fd, fe, fg}.

In some embodiments, the selection of the feature subset N1 is based on a type or context of marketing campaign, such as such as campaign size, campaign type, campaign geolocation, a product or service for which the campaign is being launched, or other objectives that the market has for the campaign. For example, the marketer can use knowledge gained in past similar campaigns to select the feature subset N1. As will be discussed herein later, the selection of the feature subset is iteratively updated, until enough look-alike or similar target audience members are identified for the campaign.

The target audience selection system then selects a first group A1 of audience members from the list L, based on the selected feature subset N1 (i.e., based on the truncated feature vectors). This also results in formation of a second group A2 of audience members in the list L who are not selected. Note that the audience members of the first group A1 are likely to be included in the marketing campaign, whereas audience members of the second group B1 are likely to be excluded from the marketing campaign. Hence, the audience members of the first group A1 are also referred to as “invited audience members,” “invited leads,” or “selected audience members,” whereas the audience members of the second group B1 are also referred to as “non-invited audience members,” “non-invited leads,” or “non-selected audience members.”

Note that the number “1” in groups A1 and B1 implies that this is a first iteration of the group selection. During a second iteration (if necessary), the first and second groups will be referred to as A2 and B2.

The target audience selection system then checks to see if the selected first group A1 and the non-selected second group A2 satisfies a hypothesis H1. Thus, the target audience selection system performs a validation check, which is based on an assumption that historically, the marketer was able to identify a pattern which led the marketer to invite a group of audience members for a marketing campaign, but leave out another group. The hypothesis H1 is tested in order to validate the selection of the feature subset N1 and the resultant selection of the first group A1. In some embodiments, the hypothesis H1 is as follows: “The similarity strength within selected audience members in the first group (i.e., the invited leads) is greater than the similarity strength between selected audience members in the first group and non-selected audience members (i.e., the non-invited leads) in the second group.”

In testing the hypothesis H1, mean Euclidean distance between the above discussed truncated feature vectors is used as a metric for the similarity strength. Note that as discussed herein, the lower (smaller) the Euclidean mean distance, the higher (or greater) is the similarity strength. Thus, the hypothesis H1 translated to verifying whether the average inner distance (e.g., mean Euclidean distance) between invited leads is smaller than the mean outer distance (e.g., mean Euclidean distance) between invited and non-invited leads. As discussed, the selected audience members in the first group A1 are the invited leads, and the non-selected audience members in the second group B1 are the non-invited leads.

Assume that (D_invited_invited) is the mean Euclidean distance among audience members of the selected group A1, and (D_invited_noninvited) is the mean Euclidean distance between audience members of the selected group A1 and the nonselected group B1. Finally, to check hypothesis H1, the following difference in distance is checked: D1=(D_invited_invited)−(D_invited_noninvited). The hypothesis H1 is satisfied if D1 is less than 0 with at least a threshold confidence level, e.g., such that the probability-value (p-value) is less than a threshold value.

If the hypothesis H1 is not validated, this implies that the selected audience members in group A1 is not similar enough, compared to a similarity between the selected audience members in group A1 and the non-selected audience members in group B1. For example, if the hypothesis H1 is not validated, this also implies that the selection of the feature subset N1 may not have been optimal or near optimal. As a result, the selected audiences in the first group A1 is not dissimilar enough with respect to the non-selected audiences in the second group B1.

If the hypothesis H1 is not validated, in some embodiments, the target audience selection system repeats the selection of the subset of features. For example, during the second iteration, the target audience selection system may select feature subset N2 from the N features, where N2 is different from N1. For example, feature subsets N1 and N2 can partially overlap, but not fully overlap. The model generation module generates another model or similarity graph based on the new subset N2 of selected features. Then the target audience selection system re-selects the first group A2 using the model, in turn identifying the second group B2 of non-selected audience. The target audience selection system checks for validation of the hypothesis H1, and iteratively repeats the selection of the feature subset and selection of the first and second groups, until the hypothesis H1 is validated.

If the hypothesis H1 is validated, this implies that the audience members within the selected group A2 are look-alike or similar audience members, and audience members between the selected group A2 and the non-selected group B2 are dissimilar or not look-alike audiences. Thus, the target audience selection system takes into account the context of the marketing campaign, as well as knowledge learned from past similar marketing campaign, to select a set of relevant attributes or features that will result in contextual similarity among the audience members within the selected group A2.

The selection of the set of relevant attributes or features are done iteratively, based on validating the statistical hypothesis testing of hypothesis H1 on the similarity graph. Thus, the model generation module is trained iteratively to generate a model to satisfy the hypothesis H1. During the first iteration, the training involves generating a first model or similarity graph based on the subset N1 of features. During the second iteration, the training involves generating a second model or similarity graph based on the subset N2 of features. This training continues, until the hypothesis H1 is validated, as will be discussed in turn.

Once the hypothesis H1 is validated, the target audience selection system causes to initiate the marketing campaign using the selected audience members from the first group. For example, if the above discussed process undergoes two iterations before the hypothesis H1 is validated, then selected audience members of the first group A2 is used to initiate the marketing campaign.

Once the marketing campaign begins, the marketer can use knowledge learned from the campaign to fine-tune the selection of the first group A2. For example, as and when the campaign proceeds, the target audience selection system identifies a first subset A+ of the first group A2 that have responded positively so far to the campaign, and a second subset A− of the first group A2 that have so far responded negatively or haven't responded yet to the marketing campaign. For example, the marketing campaign can last for a time duration, such as less than 1 month, about 1 month, 3 months, 6 months, or longer, and the identification operations at can be repeated continuously or at periodic interval throughout the lifespan of the marketing campaign.

Audience members included in the first subset A+ of the first group A2 are identified as “α+” to indicate that these members have responded positively so far in the marketing campaign, and audience members included in the second subset A− of the first group A2 are identified as “α−” to indicate that these members have not yet responded positively so far in the marketing campaign.

In an example, the marketer may not be able to directly influence each and every positive or negative outcome of the marketing campaign. In some examples, the feature vector of an α− audience member may sufficiently match with the feature vector of an α+ audience member, yet the two audience members can respond differently to the marketing campaign, as will be discussed in turn. In such scenarios, it may be difficult to discern any pattern between the two subsets A+ and A− of the first group A2. However, in some other examples, there may be some pattern or distinguishing factors between the two subsets A+ and A− of the first group A2, as will be discussed in turn.

In some embodiments, the target audience selection system checks to determine whether the first subset A+ and the second subset A− validate a hypothesis H2. In an example, the hypothesis H2 is as follows: “The similarity strength within members of subset A+ is greater than the similarity strength between members of subset A+ and members of subset A−.”

In testing the hypothesis H2, average or mean Euclidean distance is used as a metric for the similarity strength. Note that as discussed herein previously, the lower the mean Euclidean distance, the higher is the similarity strength. Thus, in essence, hypothesis 2 tests whether a mean inner distance (e.g., mean or average Euclidean distance) between successful leads (i.e., members of subset A+) is smaller than a mean outer distance (e.g., mean or average Euclidean distance) between successful leads (i.e., members of subset A+) and non-successful leads (i.e., members of subset A−). In an example, if the hypothesis H2 is not validated, this implies that successful audience members α+ do not have relatively strong similarity among themselves. In such a case, one or more additional non-selected audience members from the group B2, who have strong similarity with the successful audience members α+, can be selected for the marketing campaign.

In an example, a failure to validate hypothesis H2 may not necessitate a repetition of selection of the subset of features. For example, such a failure can imply that the marketing campaign has not been executed long enough to allow the groups A+ and A− to differentiate from one other.

In some embodiments, the target audience selection system can expand a previous selection of target audience members for a marketing campaign. Put differently, the target audience selection system can identify one or more audience members from the non-selected group B2 who are relatively strongly similar or look-alike to the successful audience members α+ of subset A+, and move such identified audience members from the non-selected group B2 to the selected group A2.

A measure of relatively strong similarity can be implementation specific. For example, to determine the above discussed relatively strong similarity, a first average of distances between a non-selected audience member of group B2 and members of the subset A+ is determined. Also, a second average of distances between the non-selected audience member of group B2 and members of the subset A− is determined. Then, if the first average is less than the second average, then the non-selected member is identified to be similar to the subset A+ compared to the subset A−.

Subsequently, such audience members, who are moved from group B2 to A2, are also be made part of the marketing campaign. This allows the marketer to use information gather from the marketing campaign so far, to expand the scope of the campaign to include audience members who are similar or look-alike to those audience who have responded positively to the campaign so far. Numerous variations and embodiments will be appreciated in light of this disclosure.

System Architecture

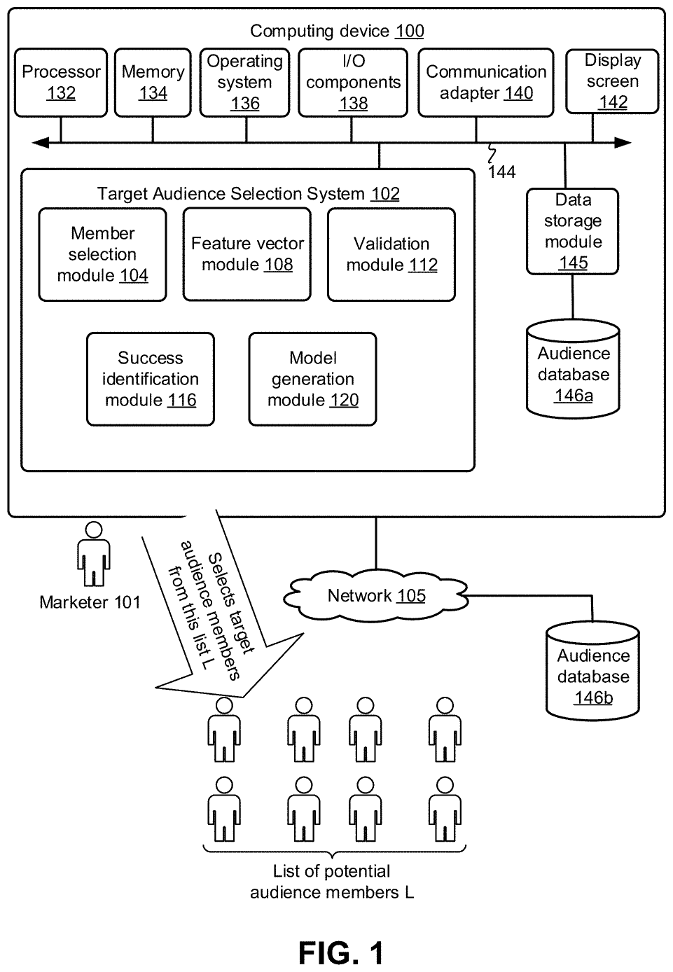

FIG. 1 is a block diagram schematically illustrating selected components of an example computing device 100 (also referred to as device 100) configured to select target audience members for a marketing campaign from a list L of potential audience members, in accordance with some embodiments of the present disclosure. As can be seen, the device 100 includes a target audience selection system 102 (also referred to as system 102) that allows the device 100 to select the target audience members for the marketing campaign from the list L of potential audience members. As will be appreciated, the configuration of the device 100 may vary from one embodiment to the next. To this end, the discussion herein will focus more on aspects of the device 100 that are related to selecting target audience members, and less so on standard componentry and functionality typical of computing devices.

The device 100 comprises, for example, a computer, a laptop, a desktop, a tablet computer, a smartphone, and/or any other computing device that can select target audience members, as further explained herein. In the illustrated embodiment, the device 100 includes one or more software modules configured to implement certain functionalities disclosed herein, as well as hardware configured to enable such implementation. These hardware and software components may include, among other things, a processor 132, memory 134, an operating system 136, input/output (I/O) components 138, a communication adaptor 140, a display screen 142, data storage module 145, and the system 102. A bus and/or interconnect 144 is also provided to allow for inter- and intra-device communications using, for example, communication adaptor 140. Note that in an example, components like the operating system 136 and the system 102 can be software modules that are stored in memory 134 and executable by the processor 132. In another example, one or more modules of the system 102 can be implemented at least in part by hardware, such as by Application-Specific Integrated Circuit (ASIC) or microcontroller with one or more embedded routines. The bus and/or interconnect 144 is symbolic of all standard and proprietary technologies that allow interaction of the various functional components shown within the device 100, whether that interaction actually takes place over a physical bus structure or via software calls, request/response constructs, or any other such inter and intra component interface technologies, as will be appreciated.

In an example, the communication adaptor 140 of the device 100 can be implemented using any appropriate network chip or chipset allowing for wired or wireless connection to network 105 and/or other computing devices and/or resources. To this end, the device 100 is coupled to the network 105 via the adaptor 140 to allow for communications with other computing devices and resources, such as a remote document database 146b. The network 105 is any suitable network over which the computing devices communicate. For example, network 105 may be a local area network (such as a home-based or office network), a wide area network (such as the Internet), or a combination of such networks, whether public, private, or both. In some cases, access to resources on a given network or computing system may require credentials such as usernames, passwords, or any other suitable security mechanism.

In an example, the device 100 has access to the local database 146a and/or a remote database 146b, any one of both of which stores the list L of potential audience members. In an example, the remote database 146b is a cloud-based database, where the device 100 can access the database 146b over the network 105. The document database 146a is coupled to the data storage module 145, which facilitates read and write access to database 146a.

Processor 132 can be implemented using any suitable processor, and may include one or more coprocessors or controllers, such as an audio processor or a graphics processing unit, to assist in processing operations of the device 100. Likewise, memory 134 can be implemented using any suitable type of digital storage, such as one or more of a disk drive, solid state drive, a universal serial bus (USB) drive, flash memory, random access memory (RAM), or any suitable combination of the foregoing. Operating system 136 may comprise any suitable operating system, such as Google Android, Microsoft Windows, or Apple OS X. As will be appreciated in light of this disclosure, the techniques provided herein can be implemented without regard to the particular operating system provided in conjunction with device 100, and therefore may also be implemented using any suitable existing or subsequently-developed platform. The device 100 also includes one or more I/O components 138, such as one or more of a tactile keyboard, a display, a mouse, a touch sensitive display, a touch screen display, a trackpad, a microphone, a camera, scanner, and location services. In general, other standard componentry and functionality not reflected in the schematic block diagram of FIG. 1 will be readily apparent, and it will be further appreciated that the present disclosure is not intended to be limited to any specific hardware configuration. Thus, other configurations and subcomponents can be used in other embodiments.

As can be further seen, the target audience aelection aystem 102 comprises a member selection module 104, a feature vector module 108, a validation module 112, a success identification module 116, and a model generation module 120. As will be appreciated, some modules may be combined with other modules but are shown here as separate to facilitate discussion. A marketer 101 operates the device 100 to select target audiences for a marketing campaign, from the list L of potential audience members. In some embodiments, each audience in the list is associated with a corresponding feature vector comprising corresponding values of a plurality of features. Examples of features include demographic features (such as age, gender, nationality, race), firmographic features (such as work place, job title, income), and/or behavioral features (such as interest in video gaming, interest in science). In some embodiments, the feature vector module 108 maintains the feature vectors for various audience members, and calculates distance (such as Euclidian distance) between two feature vectors associated with two respective audience members.

In some embodiments, the model generation module 120 iteratively generates a model or similarity graph, where during each iteration, a corresponding subset of features are used to build the model. In some embodiments, the member selection module 104 selects target audience members from the list L of potential audience members, based on the similarity graph, based on the feature vectors and the Euclidian distances between the feature vectors. In some embodiments, the success identification module 116 identifies audience members who have responded positively to a marketing campaign. In some embodiments, the member selection module 104 also opportunistically expands the selection of the target audience members, based on the success identification module 116 identifying positively-responding audience members. The validation module 112 is used to test and validate one or more hypothesis, based on which the member selection module 104 can intelligently select the target audience members. Each of these components of the system 102 will be discussed in further detail in turn.

The components of the system 102 can be in communication with one or more other devices including other computing devices of a user, server devices (e.g., cloud storage devices), licensing servers, or other devices/systems. Although the components of the system 102 are shown separately in FIG. 1, any of the subcomponents may be combined into fewer components, such as into a single component, or divided into more components as may serve a particular implementation.

In an example, the components of the system 102 performing the functions discussed herein with respect to the system 102 may be implemented as part of a stand-alone application, as a module of an application, as a plug-in for applications, as a library function or functions that may be called by other applications, and/or as a cloud-computing model. Thus, the components of the system 102 may be implemented as part of a stand-alone application on a personal computing device or a mobile device. Alternatively, or additionally, the components of the system 102 may be implemented in any application that allows digital content processing and displaying.

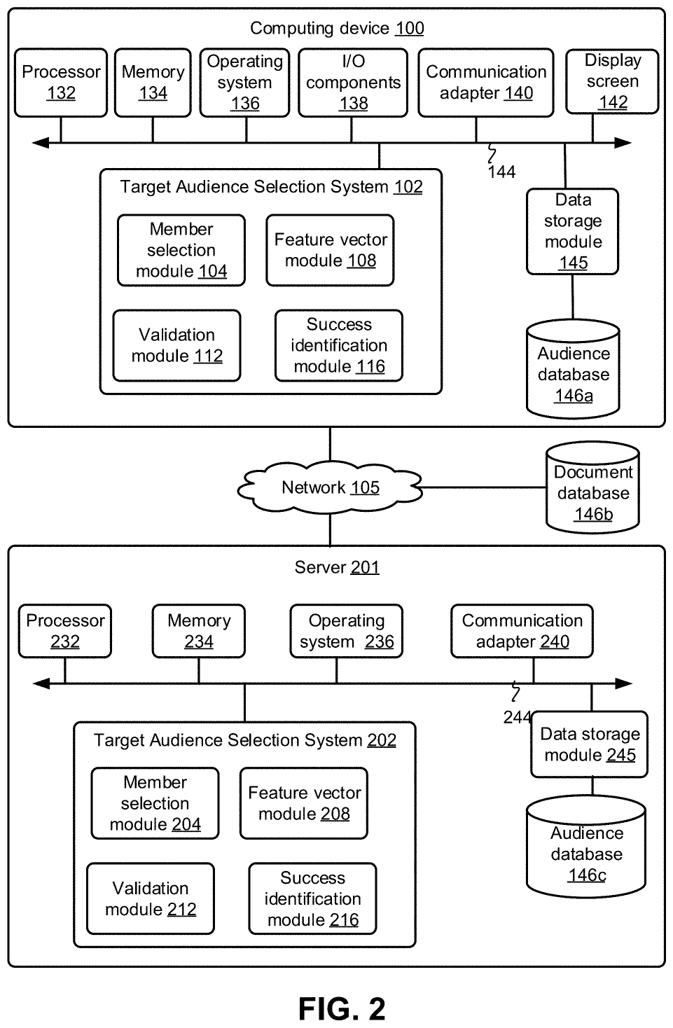

FIG. 2 is a block diagram schematically illustrating selected components of an example system 200 comprising the computing device 100 of FIG. 1 communicating with server device(s) 201, where the combination of the device 100 and the server device(s) 201 (henceforth also referred to generally as server 201) are configured to select target audience members for a marketing campaign from a list L of potential audience members, in accordance with some embodiments.

In an example, the communication adaptor 140 of the device 100 can be implemented using any appropriate network chip or chipset allowing for wired or wireless connection to network 105 and/or other computing devices and/or resources. To this end, the device 100 is coupled to the network 105 via the adaptor 140 to allow for communications with other computing devices and resources, such as the server 201 and the document database 146b.

In one embodiment, the server 201 comprises one or more enterprise class devices configured to provide a range of services invoked to provide selection of target audience members, as variously described herein. Although one server 201 implementation of the audience member selection system is illustrated in FIG. 2, it will be appreciated that, in general, tens, hundreds, thousands, or more such servers can be used to manage an even larger number of the list L of potential audience members and selection of the target audience members from the list.

In the illustrated embodiment, the server 201 includes one or more software modules configured to implement certain of the functionalities disclosed herein, as well as hardware configured to enable such implementation. These hardware and software components may include, among other things, a processor 232, memory 234, an operating system 236, a target audience selection system 202 (also referred to as system 202), data storage module 245, and a communication adaptor 240. A document database 146c (e.g., that comprises a non-transitory computer memory) comprises the list L of potential audience members, and is coupled to the data storage module 245. A bus and/or interconnect 244 is also provided to allow for inter- and intra-device communications using, for example, communication adaptor 240 and/or network 205. Note that components like the operating system 236 and system 202 can be software modules that are stored in memory 234 and executable by the processor 232. The previous relevant discussion with respect to the symbolic nature of bus and/or interconnect 144 is equally applicable here to bus and/or interconnect 244, as will be appreciated.

Processor 232 is implemented using any suitable processor, and may include one or more coprocessors or controllers, such as an audio processor or a graphics processing unit, to assist in processing operations of the server 201. Likewise, memory 234 can be implemented using any suitable type of digital storage, such as one or more of a disk drive, a universal serial bus (USB) drive, flash memory, random access memory (RAM), or any suitable combination of the foregoing. Operating system 236 may comprise any suitable operating system, and the particular operation system used is not particularly relevant, as previously noted. Communication adaptor 240 can be implemented using any appropriate network chip or chipset which allows for wired or wireless connection to network 205 and/or other computing devices and/or resources. The server 201 is coupled to the network 205 to allow for communications with other computing devices and resources, such as the device 100. In general, other componentry and functionality not reflected in the schematic block diagram of FIG. 2 will be readily apparent in light of this disclosure, and it will be further appreciated that the present disclosure is not intended to be limited to any specific hardware configuration. In short, any suitable hardware configurations can be used.

The server 201 can generate, store, receive, and transmit any type of digital documents, such as the list L of potential audience members and/or a list of selected audience members that are to be accessed by the device 100. The target audience selection system 202 comprises a member selection module 204, a feature vector module 208, a validation module 212, and a success identification module 216, each of which can be similar to the corresponding components within the device 100, as discussed with respect to FIG. 1.

In some embodiments, the location of some functional modules in the system 200 may vary from one embodiment to the next. Any number of client-server configurations will be apparent in light of this disclosure. In still other embodiments, the techniques may be implemented entirely on a user computer, e.g., simply as stand-alone user marking sharing application. Similarly, while the member selection module 104 is shown on the client side in an example case, it may be on the server side in other embodiments, such as the cloud-based member selection module 204. In an example, the document database can be local or remote to the systems 102, 102, so long as it is accessible by the target audience member selection system that is implemented by the system 102 and/or implemented by the system 202.

Methodology and Operation

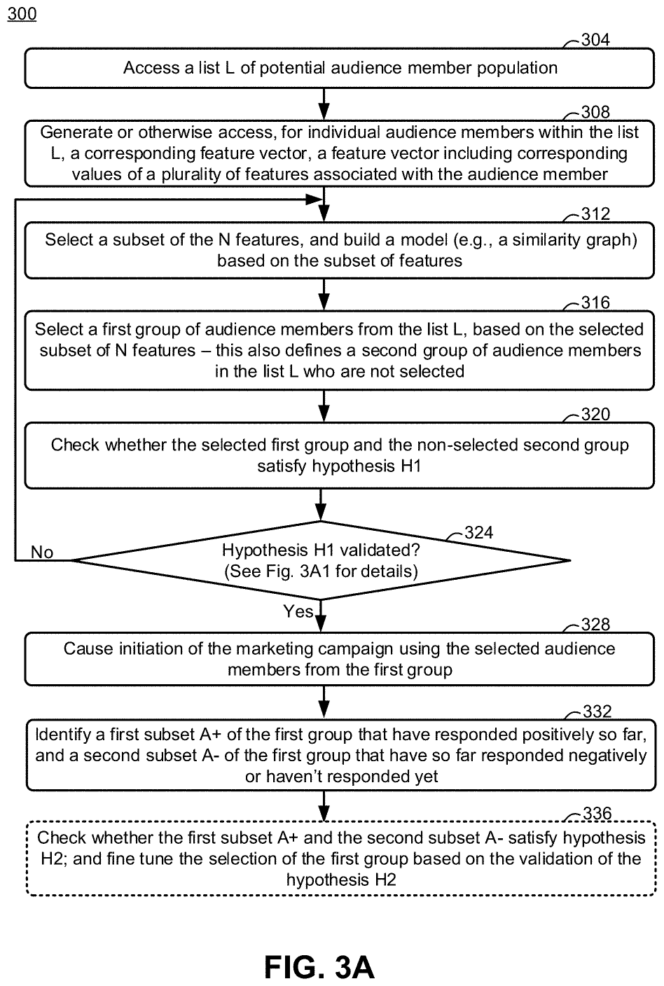

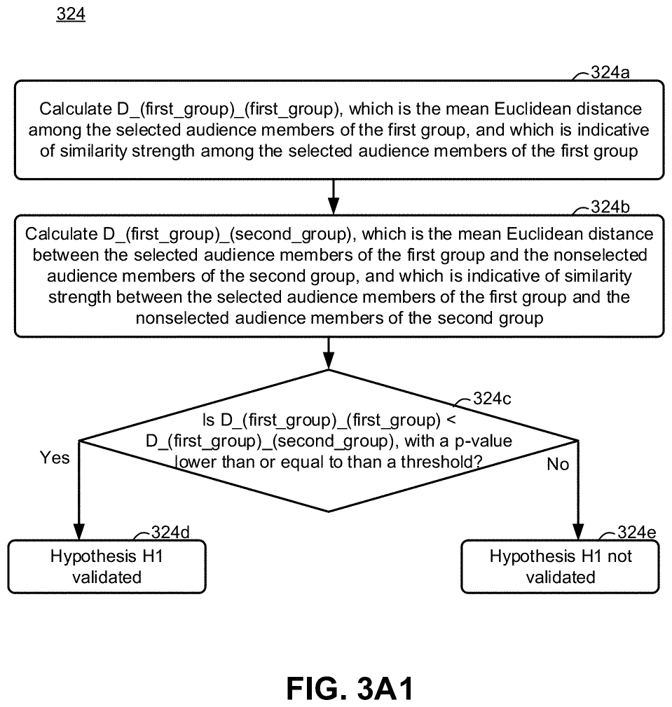

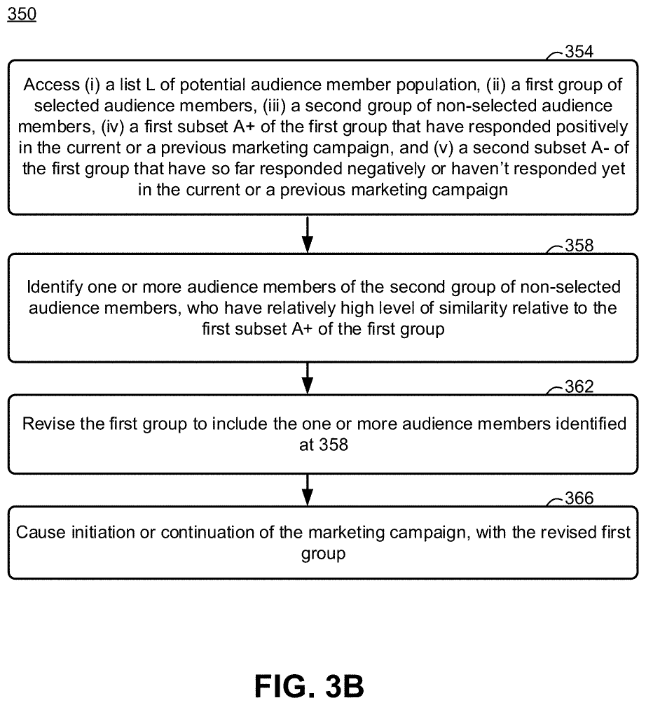

FIG. 3A is a flowchart illustrating an example method 300 for selecting target audience members for a marketing campaign, in accordance with some embodiments of the present disclosure. Method 300 can be implemented, for example, using the system architecture illustrated in FIGS. 1 and/or 2, and described herein, e.g., using the systems 102 and/or 202. However other system architectures can be used in other embodiments, as apparent in light of this disclosure. To this end, the correlation of the various functions shown in FIG. 3A to the specific components and functions illustrated in FIGS. 1 and 2 is not intended to imply any structural and/or use limitations. Rather, other embodiments may include, for example, varying degrees of integration wherein multiple functionalities are effectively performed by one system. In another example, multiple functionalities may be effectively performed by more than one system.

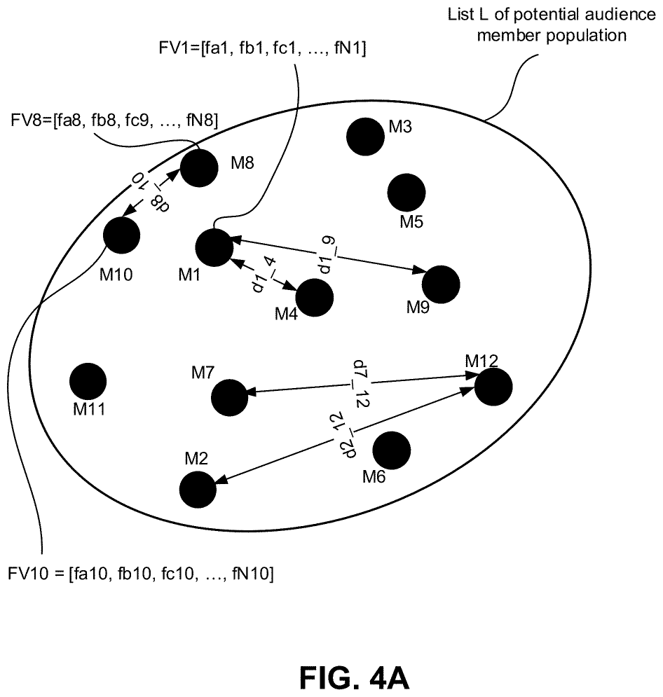

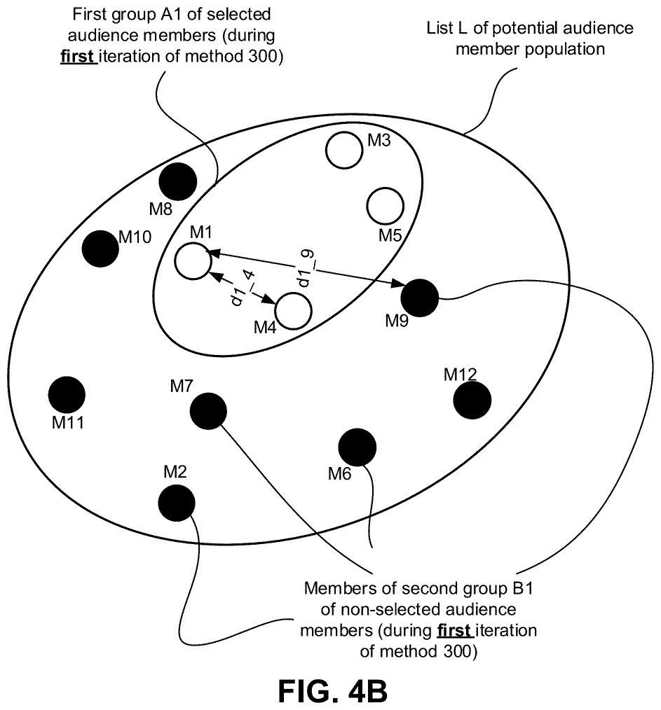

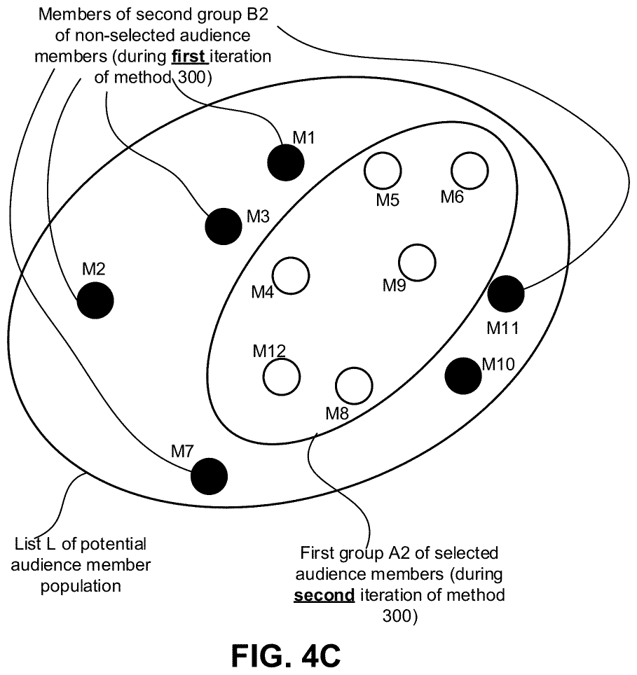

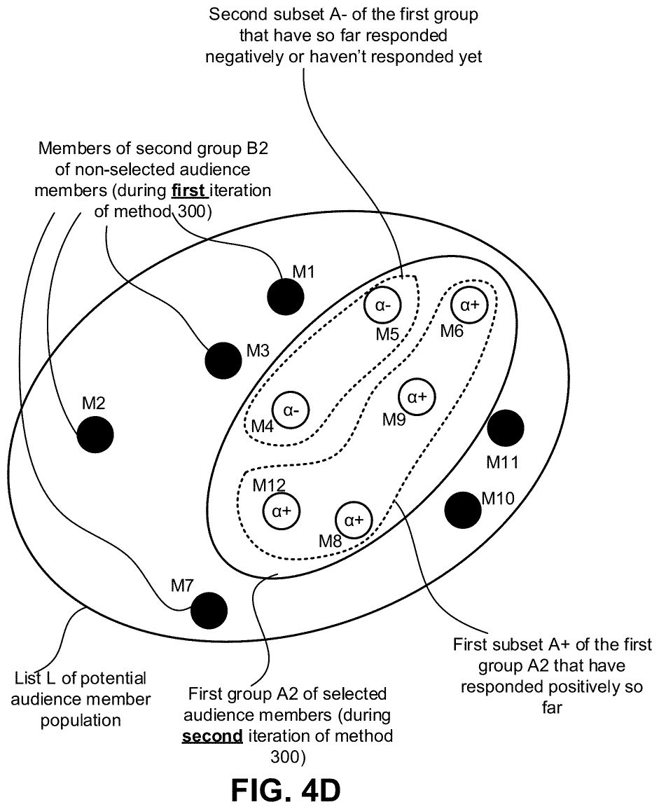

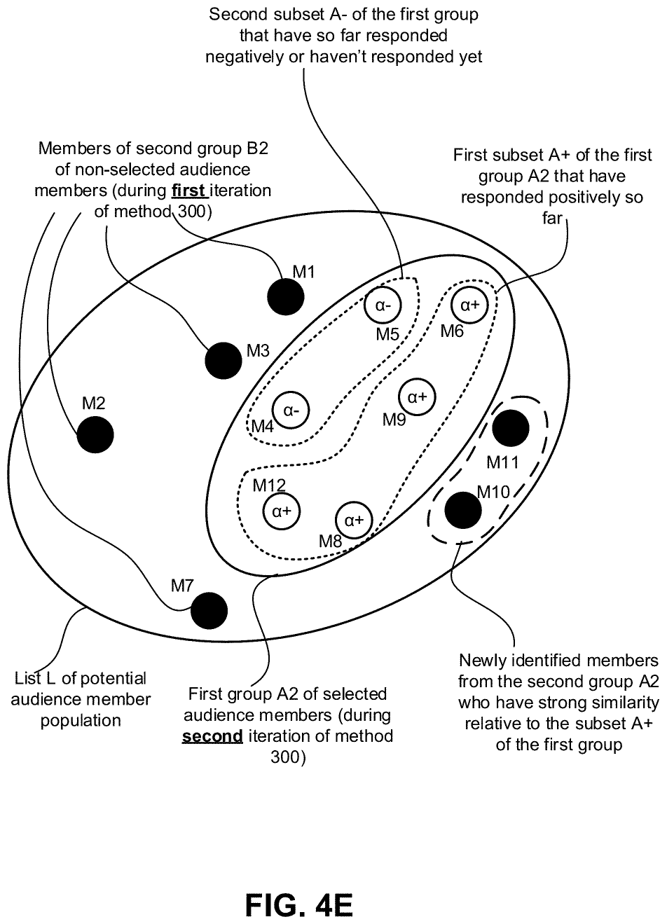

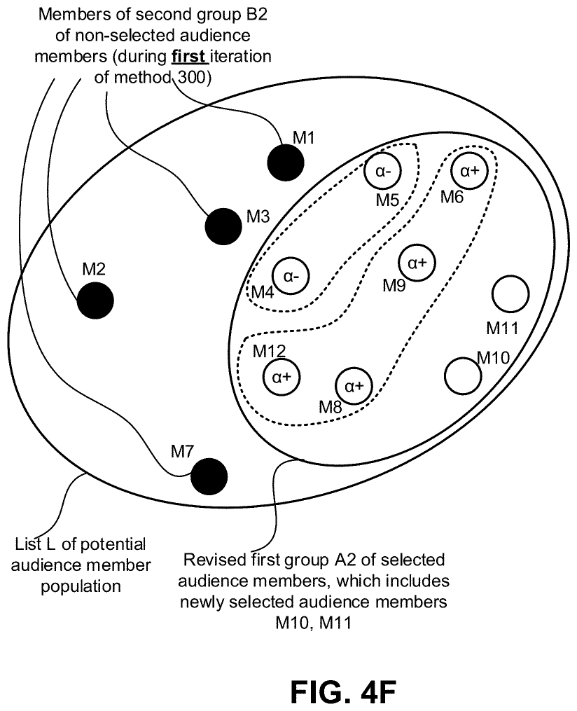

FIGS. 4A-4F illustrate various example scenarios associated with selecting target audience members for a marketing campaign, in accordance with some embodiments of the present disclosure. The method 300 of FIG. 3A (and methods 324 and 350 of FIGS. 3A1 and 3B, respectively, discussed herein in turn) will be discussed with respect to the various example scenarios discussed with respect to FIGS. 4A-4F.

Referring to the method 300 of FIG. 3A, at 304, the target audience selection system 102 and/or 202, such as the member selection module 104, accesses a list L of potential audience member population. For example, FIG. 4A illustrates an example of the list L of potential audience member population, such as audience members M1, M2, . . . , M12. As will be discussed in further detail in turn, FIG. 4A is an example schematic representation of a mode, such as a similarity graph, in which the potential audience members are placed based on Euclidean distances between two members.

The example list L of FIG. 4A illustrates individual audience member using a black circle. Although the example list L of FIG. 4A illustrates merely 12 potential audience members, in a practical marketing campaign, the list of potential audience members is likely to be larger, such as hundreds, thousands, tens or hundreds of thousands, or higher number of potential audience members, depending on the quantum of audience outreach the marketer wants to achieve. For example, for a local marketing campaign, the marketer can generate the list L of people residing in the neighborhood (e.g., list of people residing in a zip code where the campaign is taking place, as well as people residing in one or more adjacent zip codes). In contrast, for a nationwide product launch, the list L is likely to include a relatively larger number of audience spread throughout the nation.

The list L is usually available to the marketer who is launching the marketing campaign. For example, the marketer can buy the list from an appropriate source that sells such a list of potential audience members. In another example, a person can previously sign up with the marketer, e.g., to receive periodic emails from the marketer, and the marketer can add that person to the list L. In another example, a person may have purchased a product from the marketer or its affiliates, based on which the person can be included in the list L. Thus, the marketer can receive and/or generate the list L using one or more appropriate manners, mere examples of some of which are discussed herein.

The list L can include audience members who may or may not be interested in the marketing campaign. For example, assume that the marketing campaign is to launch a new beauty product. The target audience can be, merely as an example, females aged 18 or higher. However, the initial list L can include audience of all demographics, such as male and female. Thus, the list L can possibly include audiences (such as men over 65) who are likely to be disinterested in the marketing campaign for the beauty product, as well as audiences (such as females aged between 21 and 65) who are likely to be interested in the marketing campaign.

The graphical representation of audience members in FIG. 4A represents a model, such as a similarity graph, generated by the model generation module 120. The similarity graph of FIG. 4A is generated based on feature vectors associated with individual audience members, as will be discussed in turn.

As will be discussed in further detail, in some examples, the similarity graph of FIG. 4A is generated at block 312 of the method 300, using a subset of N features. However, the similarity graph of FIG. 4A is also discussed with respect to blocks 304 and 308, which further discuss the list L of potential audience members and the concept of the feature vectors.

Similarity graphs can arise in the form of networks, which capture pairwise interactions between discrete objects, such as audience pairs of FIG. 4A. In an example, K-Nearest Neighbor (K-NN) graph algorithm may be used to construct the similarity graph of FIG. 4A. In another example, ANNOY (Approximate Nearest Neighbors Oh Yeah) is used to construct the similarity graph of FIG. 4A.

Referring again to FIG. 3A, the method 300 proceeds from block 304 to block 308, where the system 102 and/or 202, such as the feature vector module 108, generates or otherwise accesses, for individual audience members within the list L, a corresponding feature vector. As discussed, a feature vector includes corresponding values of N features, where N is a positive integer of more than one. For example, FIG. 4A illustrates example feature vector FV1 for audience M1, feature vector FV8 for audience M8, and feature vector FV10 for audience M10. Feature vectors for other audience members in FIG. 4A are not illustrated for purposes of illustrative clarity.

A feature vector FV includes a plurality of features fa, fb, fc, fN, i.e., includes N features, where N is a positive integer. A feature is representative of an attribute or characteristic associated with the audiences. In some embodiments, features comprise demographic features, behavioral features, and/or firmographic features.

Examples of demographic features include a person's age, gender, educational qualification, number of children in the household, address, and/or other attributes that are associated with the person's demography. Examples of firmographic features include income level, job title, the person's workplace details (e.g., private organization, government organization, self-employed), one or more attributes that are associated with the workplace, firm, or organization in which the audience works, and/or other job-related details.

In an example, behavioral features include characteristics or attributes associated with the person's behavior, such as hobbies, whether the household has a game console, whether the person plays video games, and/or other behavioral attributes. For a specific marketing campaign for inviting audiences to a seminar, examples of behavioral features can include whether the person has previously attended a similar seminar, total number of seminar requests sent earlier to the person, number of seminar requests accepted by the person, total number of seminars attended by the person in the last 5 years, whether the person attended a seminar for which the person had to pay, and/or other appropriate behavioral features.

Sometimes the demographic features and/or behavioral features can at least in part overlap. For example, a demographic feature can be whether a person has a toddler or an infant, and a behavioral feature can be whether the person buys diapers. In such an example, the demographic feature and the behavioral feature are somewhat intertwined, as a person having a toddler or infant is also likely to buy diapers.

For a specific audience, each feature is assigned a corresponding measurable feature value. For example, for a feature comprising address of an audience member, the assigned feature value can be the zip code. In another example, for a feature comprising job title of an audience member, the assigned feature value can be 1 for legal job, 2 for job in the health care sector, 3 for job in an engineering firm, and so on. In yet another example, for a feature comprising gender, the assigned feature value can be 1 for male, 2 for female, or 3 for undisclosed or unknown gender. In yet another example, for a feature comprising age, the assigned feature value can be the actual age of the audience member. In an example, for a feature comprising salary of an audience member, the assigned feature value can be 1 income less than $50,000, 2 for income between $50,000 to 75,000, or 3 for income above $75,000. However, in yet another example, for the feature comprising salary of the audience member, the assigned feature value can be the actual salary, if provided by the audience member. In a further example, for the feature comprising salary of the audience member, the assigned feature value can be $40,000 for salary of $50,000 or less, can be $60,000 for salary between $50,000 to 75,000, or can be $90,000 for salary above $75,000. Thus, the mapping between the actual salary and the assigned feature value can be implementation specific or user configurable.

Referring again to FIG. 4A, the example feature vector for audience M1 is FV1=[fa1, fb1, fc1, . . . , fN1], the example feature vector for audience M8 is FV8=[fa8, fb8, fc9, . . . , fN8], and the example feature vector for audience M10 is FV10=[fa10, fb10, fc10, . . . , fN10]. Assume that the first feature fa in the feature vector is age, the second feature fb in the feature vector is an address, and the third feature fc in the feature vector is income. Thus, merely as an example, the feature vector FV1 for audience M1 can be [22, 97229, 3, . . . ], implying that the audience M1 is 22 years old, has an address with a zip code of 97229, and has an income level of 3 (e.g., which may correspond to an income of $75,000 or higher in one of the examples discussed herein above). Similarly, in another example, the feature vector FV8 for audience M8 can be [30, 47229, 2, . . . ], implying that the audience M8 is 30 years old, has an address with a zip code of 47229, and has an income level of 2 (e.g., which may correspond to an income of between $50,000 to $75,000). Similarly, in yet another example, the feature vector FV10 for audience M10 can be [62, 50678, 1, . . . ], implying that the audience M10 is 62 years old, has an address with a zip code of 50678, and has an income level of 1 (e.g., which may correspond to an income of less than $50,000).

In an example, for a specific audience member, values of not all features may be available. For example, assume an age of the audience member M2 is not known, whereas the address and the income for the audience member M2 is known. In such a scenario, the feature value corresponding to the feature age can be left blank, can be assigned a flag indicating that the age is unknown, or can be assigned an average age value.

As discussed, a feature vector associated with an audience has values for features fa, fb, . . . , fN. Thus, there can be N number of features in a feature vector, where N is an integer. The feature vector is defined within an N-dimensional plane. Each audience has a respective coordinate in the N-dimensional place, where the coordinate is defined by the corresponding feature vector.

As discussed herein, FIG. 4A is a similarity graph generated based on feature vectors associated with individual audience members. Any appropriate similarity graphing algorithm can be employed for generating the similarity graph of FIG. 4A, such as K-Nearest Neighbor (K-NN) graph algorithm, ANNOY (Approximate Nearest Neighbors Oh Yeah), or another appropriate similarity graphing algorithm. For example, a distance between two audience members in the similarity graph of FIG. 4A is indicative of a Euclidian distance between the feature vectors of the two audiences.

Thus, for example, in the similarity graph of FIG. 4A, the audience M1 is placed relatively near to audiences M3 and M5, while audience M7 is placed relatively far from the audience M1. This implies that a Euclidian distance between audience M1 and M3, or a Euclidian distance between audience M1 and M5 is less than a Euclidian distance between audience M1 and M7, for example.

Few example Euclidian distances between two audiences are illustrated in FIG. 4A. For example, a Euclidian distance between audiences M2 and M12 is illustrated as d2_12 in FIG. 4A. In another example, a Euclidian distance between audiences M7 and M12 is illustrated as d7_12 in FIG. 4A. Similarly, a Euclidian distance between audiences M8 and M10 is illustrated as d8_18 in FIG. 4A. In general, for audience members Mx and My, a corresponding Euclidian distance between the associated feature vectors FVx and FVy is denoted as dx_y (e.g., assuming x is less than y).

In general, assume an audience Mx having a feature vector FVx=[fax, fbx, fcx, . . . , fNx], and another audience My having a feature vector FVy=[fay, fby, fcy, fNy]. Then the Euclidian distance dx_y between audiences Mx and My (e.g., which is the Euclidian distance between the associated feature vectors FVx and FVy) is calculated as follows:

$$dx\_y = \sqrt{\begin{matrix}{( fax - fay )}^{2} + {( fbx - fby )}^{2} + \\ {( fcx - fcy )}^{2} + ⋯ + {( fNx - fNy )}^{2}\end{matrix}} . \qquad Equation 1$$

Equation 1 can be rewritten as follows:

dx_y=∥FVx−Fvy∥, Equation 1a

where the ∥.∥ operator outputs Euclidian distance between two vectors. Although Euclidian distance or L² norm is used in equations 1 and 1a, other type of distances may also be utilized, such as distances calculated based on L0 norm, L1 norm, and/or the L-infinity norm.

Thus, using equations 1, 1a, Euclidian distance between any pair of audience members can be calculated. The Euclidian distance between two audience members is representative of how similar or look-alike the two audience members are, based on the feature values associated with the two audience members. Accordingly, the Euclidian distance between any two audience members is also associated with a “similarity strength” or “similarity value” between the two audience members.

For example, a relatively low Euclidian distance between any two audience members implies that the two audience members are relatively more similar or look-alike—accordingly, the similarity strength or similarity value between the two audience members is relatively high. On the other hand, a relatively high Euclidian distance between any two audience members implies that the two audience members are relatively less similar—accordingly, the similarity strength or similarity value between the two audience members is relatively low. Thus, the Euclidian distance between two audience members are inversely related to (e.g., inversely proportional) the similarity strength or similarity value between the two audience members.

For example, referring to FIG. 4A, the Euclidian distance d2_12 between the two audience members M2 and M12 provides an indication of how similar or look-alike the two audience members M2 and M12 are. The Euclidian distance d2_12 is a measure of similarity between the feature values of the features of the feature vectors of the two audience members M2 and M12. As discussed, the lower is the Euclidian distance d2_12, the higher is the similarity strength between the two audience members M2 and M12. The Euclidian distance d2_12 can be calculated using the equation 1 discussed above.

Referring again to FIG. 3A, the method 300 then proceeds from 308 to 312, where a subset of the N features of the feature vectors are selected by the system 102 (e.g., by the feature vector module 108). Merely as an example, assume that N=50, i.e., there are 50 different features within each feature vector FV, such as demographic, firmographic and/or behavioral features discussed herein. Of those 50 features, merely as an example, 5 features can be selected at block 312.

For example, assume that during the first iteration of the block 312, the selected subset of N is given by N1, where, merely as an example, N1={fa, fc, fd, fe, fg}. Thus, during the first iteration of the block 312, the selected subset of the N features includes features fa, fc, fd, fe, fg. Thus, in this example, N=50, and the selected subset N1 includes five features of the 50 possible features.

This results in truncated feature vectors that includes only the selected subset of features. For example, for member M1, the truncated feature vector during the first iteration of the method 300 will be [fa1, fc1, fd1, fe1, fg1]; for member M2, the truncated feature vector during the first iteration of the method 300 will be [fa2, fc2, fd2, fe2, fg2], and so on.

In some embodiments, the selection of the feature subset N1 is based on a type or context of marketing campaign, such as such as campaign size, campaign type, campaign geolocation, a product or service for which the campaign is being launched, or other objectives that the market has for the campaign. In an example, the marketer can use knowledge gained in past similar campaigns to select the feature subset N1.

In some other embodiments, the selection of the feature subset N1 is performed to build a generic similarity among the audience. This similarity can apply to several different selections of members (e.g., for multiple and different types of campaigns), without having to optimize for a specific marketing campaign. An optimized or near optimized similarity graph is the one that fits for multiple campaign contexts. In other words, the aim of subset selection is to find a subset of N that can fit multiple marketing campaigns. Thus, the selection of the feature subset N1 can be random, pseudo-random, or based on any other appropriate criteria.

As will be discussed herein in turn, the selection of the feature subset is iteratively updated, until enough distinct look-alikes or similar marketable audience members are identified, e.g., until Hypothesis H1 is validated. This results in optimizing the attributes or features that provides meaningful and contextual similarities among the marketable audience members, as discussed in turn.

For example, if the marketing campaign is to launch diapers made of organic products such as organic cotton, selected features can include whether audience members have infants or toddlers, income of the audience members, affinity of the audience members towards organic products, and/or prior purchase of organic products by the audience members. In another example, if the marketing campaign is about a webinar or seminar on patent drafting and prosecution, one or more selected features can include whether audience members have a law degree, whether the audience members have interest in intellectual property law, and/or whether the audience members are employed by a law firm.

Also at 312, the model generation module 120 generates the model comprising the similarity graph of FIG. 4A. As discussed, the similarity graph of FIG. 4A is generated based on the subset N1 of the features. Any appropriate similarity graphing algorithm can be employed for generating the similarity graph of FIG. 4A, such as K-NN graph algorithm, ANNOY, or another appropriate similarity graphing algorithm. For example, a distance between two audience members in the similarity graph of FIG. 4A is indicative of a Euclidian distance between the truncated feature vectors (e.g., comprising features of the subset N1) of the two audiences.

Referring again to FIG. 3A, the method 300 then proceeds from 312 to 316, where the system 102 (such as the member selection module 104) selects a first group of audience members from the audience members in the list L, based on the selected subset of N features. Thus, the selection is done based on the truncated feature vectors, where a truncated feature vector includes feature values of features included in the subset of N features. This also results in formation of a second group of audience members in the list L who are not selected.

For example, during a first iteration of the block 316, audience members of a first group A1 are selected, and audience members of a second group B1 are non-selected, as illustrated in FIG. 4B. For example, in FIG. 4B, the selected audience members within the first group A1 are illustrated in white circles. The non-selected audience members outside the first group A1 (i.e., within the second group B1) are illustrated in black circles. Thus, in this example, audience members M1, M3, M4, and M5 are selected in the first group A1. The non-selected audience members (such as audience members M2, M6, . . . , M12) are included in the second group B2.

As discussed, the selection of the first group A1 is based on the truncated feature vectors including feature values of the selected subset of features. For example, as discussed, during the first iteration of the blocks 312, 316, the selected subset of N is given by N1, where, merely as an example, N1={fa, fc, fd, fe, fg}. Thus, the first group A1 of audience members illustrated in FIG. 4B is selected based on features fa, fc, fd, fe, fg.

For example, referring to FIG. 4B, each of the feature values fa3, fc3, fd3, fe3, and fg3 for the audience member M3 satisfies a threshold value, and hence, the audience member M3 is included in the first group A1. Merely as an example, if the feature fa is age and if the audience members to be selected has a threshold age of 30 years, then each of the audience members have feature values for the feature fa to be less than 30. Thus, because audience members M1, M3, M4, and M5 are selected, each of fM1, fa3, fa4, and fa5 is less than 30. Similarly, each of the audience members M1, M3, M4, and M5 also satisfy similar threshold criterion for each of the features fc, fd, fe, and fg. Non-selected audience members (such as audience members M2, M6, . . . , M12) included in the second group does not satisfy one or more criteria associated with the features fa, fc, fd, fe, fg, and hence, are in non-selected group B1.

Note that further iterations of the blocks 312, 316 can result in refinement of the first group—however, audience members of the eventual first group (after the iterations of these blocks are completed) will be included in the marketing campaign, whereas audience members of the eventual second group (after the iterations of these blocks are completed) will be excluded from the marketing campaign. Hence, the audience members of the first group are also referred to as “invited audience members,” “invited leads,” or “selected audience members,” whereas the audience members of the second group are also referred to as “non-invited audience members,” “non-invited leads,” or “non-selected audience members.”

Referring again to FIG. 3A, the method 300 then proceeds from 316 to 320, where the system 102 (e.g., the validation module 112) checks to see if the selected first group and the non-selected second group satisfies a hypothesis H1. Thus, block 320 performs a validation check, which is based on an assumption that historically, the marketer was able to identify a pattern which led the marketer to invite a group of audience members for a marketing campaign, but leave out another group. The hypothesis H1 is tested in order to validate the selection of features at 312 and the resultant selection of the first group at 316.

In some embodiments, the hypothesis H1 is as follows: The similarity strength within selected audience members in the first group (i.e., the invited leads) is greater than the similarity strength between selected audience members in the first group and non-selected audience members (i.e., the non-invited leads) in the second group.

In testing the hypothesis H1, mean Euclidean distance between the above discussed truncated feature vectors is used as a metric for the similarity strength, as discussed with respect to equation 1. Note that as discussed herein previously, the lower the Euclidean mean distance, the higher is the similarity strength. Thus, the hypothesis H1 translated to verifying whether the average inner distance (e.g., mean Euclidean distance) between invited leads is smaller than the mean outer distance (e.g., mean Euclidean distance) between invited and non-invited leads. As discussed, the selected audience members in the first group are the invited leads, and the non-selected audience members in the second group are the non-invited leads.

Now referring to FIG. 4B, the selected audience members in the first group (i.e., the invited leads) comprise audience members M1, M3, M4, and M5. Thus, the “similarity strength within selected audience members in the first group” of hypothesis 1 is inversely related (e.g., inversely proportional) to the average or mean Euclidian distance between each selected audience member. The mean Euclidian distance within selected (i.e., invited) audience members in the first group is calculated as follows:

D_invited_invited=average of (d1_3, d1_4, d1_5, d3_4, d3_5, d4_5) Equation 2

Thus, in equation 2, D_invited_invited is representative of an average or mean Euclidian distance within selected audience members in the first group (i.e., the invited leads). The lower is this distance, the higher is the similarity strength among selected audience members in the first group.

Each of the individual distances in equation 2 can be calculated in accordance with equation 1 discussed herein earlier. However, note that while equation 1 calculated the distance between two feature vectors, in equation 2 the truncated version of the two feature vectors are to be used. For example, assuming that the selected subset of N is given by N1, where, merely as an example, N1={fa, fc, fd, fe, fg}, then the Euclidean distance of equation 1 can be modified as follows:

$$dx\_y = \sqrt{\begin{matrix}{( fax - fay )}^{2} + {( fcx - fcy )}^{2} + \\ {( fdx - fdy )}^{2} + \\ {( fex - fey )}^{2} + {( fgx - fgy )}^{2}\end{matrix}} . \qquad Equation 2 a$$

Thus, the distance dx_y is the now based on the truncated feature vectors [fax, fcx, fdx, fex, fgx] and [fay, fcy, fdy, fey, fgy]. Thus, for example, distance d1_3 is the Euclidean distance between truncated feature vectors FV1 and FV3 associated with audience members M1 and M3, respectively, where the distance d1_3 is calculated in accordance with equation 2a.

Equation 2 can be generalized as follows:

$$D\_invited \_invited = \frac{1}{P * ( P - 1 )} {\sum }_{i = 1}^{P} {\sum }_{j = 1 + 1}^{P} ‖ {FV}_{i} - {FV}_{j} ‖ \qquad Equation 3$$

where the set P represents the selected group (e.g., audience members M1, M3, M4, and M5), and the value of P is 4 in equation 3. The equation 3 is used for the audience members M1, M3, M4, and M5 in the selected group P, which is A1 in the example of FIG. 4A.

In equations 2 and 3, distances between each possible pair of selected audience members are calculated, which can be time consuming in some examples. In such cases, instead of calculating distances between each possible pair of selected audience members, few selected members are randomly selected, and the distance between such randomly selected members can be calculated and used in equations 2 and 3.

Referring again to the hypothesis H1, the mean Euclidian distance between selected audience members (i.e., invited leads) in the first group and non-selected audience members (i.e., the non-invited leads) in the second group are calculated as follows:

D_invited_noninvited=average of (d1_2, d1_6, . . . , d1_12, d3_2, d3_6, . . . , d3_12, d4_2, d4_6, . . . , d4_12, d5_2, d5_6, . . . , d5_12,) Equation 4

Note that the individual distances in equation 4 are distances between the truncated feature vectors, as discussed with respect to equation 2a. Thus, equation 4 includes average of distances between each selected audience member and each non-selected audience member. The higher is this distance, the lower is the similarity strength between each selected audience member and each non-selected audience member. Thus, a plurality of pairs of audience members are identified, where each pair includes a corresponding selected audience member and a corresponding non-selected audience member, for each pair the corresponding distance is determined, and the determined distances are averaged in equation 4.

In an example, all combination of distances between each selected audience member and each non-selected audience member are included in equation 4. For example, the selected members of the group A1 comprises M1, M3, M4, and M5, whereas the non-selected members of the group B1 comprises M2, M6, . . . , M12. Each of the distances in equation 4 can be calculated in accordance with equation 2a discussed herein earlier. For example, distance d1_2 is the Euclidean distance between truncated feature vectors FV1 and FV2 associated with audience members M1 and M2, respectively, where the distance d1_2 is calculated in accordance with equation 2a discussed herein earlier.

Equation 4 can be generalized as follows:

$$D\_invited \_noninvited = \frac{2}{Q * ( 2 Q - P - 1 )} {\sum }_{i = 1}^{Q} {\sum }_{j = 1 + 1}^{P} ‖ {FV}_{i} - {FV}_{j} ‖ \qquad Equation 5$$

where the set P represents the selected group (e.g., audience members M1, M3, M4, and M5), and the value of P is 4 in equation 5. Also, the set Q represents the non-selected group (e.g., audience members M2, M6, . . . , M12), and the value of Q is 5 in equation 8. In equation 5, it is assumed that Q≥P, i.e., number of non-selected members are greater than the number of selected members. However, if P≥Q (i.e., number of selected members are greater than the number of non-selected members), then equation 5 is modified as follows:

$$D\_invited \_noninvited = \frac{2}{P * ( 2 P - Q - 1 )} {\sum }_{i = 1}^{P} {\sum }_{j = 1 + 1}^{Q} ‖ {FV}_{i} - {FV}_{j} ‖ \qquad Equation 5 a$$

In equations 4, 5, and 5a, distances between each possible pair of invited and non-invited audience members are calculated, which can be time consuming in some examples. In such cases, in some embodiments, instead of calculating distances between each such possible pairs, few invited and few non-invited members can be randomly selected, and the distance between such randomly selected members can be calculated and used in equations 4, 5, and 5a.

Finally, to check hypothesis H1, the following difference in distance is checked:

D1=(D_invited_invited)−(D_invited_noninvited), Equation 6

where D_invited_noninvited and D_invited_invited are computed based on equations 2-5a discussed herein above. The hypothesis H1 is satisfied if D1 is less than 0 with at least a threshold confidence level. The confidence level is a measured using the p-value or probability value, which is commonly used in hypothesis testing.

Thus, the hypothesis H1 is validated if:

D1<0, and

p-value<threshold value (e.g., 0.025 for a 95% level of confidence). Equation 7

Thus, in equation 7, the threshold p-value is 0.025, although another appropriate threshold p-value can also be used. In an example, the hypothesis testing of H1 is a one-tail test and therefore, the similarity is relatively significantly different and contextual with a p-value threshold of 0.025 at a 95% level of confidence. In contrast, as will be discussed herein in turn, the p-value threshold for a second hypothesis test H2 can be relatively higher (0.05 at 95%), as a symmetric (e.g., two-tail) difference is to be considered.

Referring again to FIG. 3A, the method 300 then proceeds from 320 to 324, where the system 102 (such as the member selection module 104) checks to see if the hypothesis H1 is validated, e.g., as discussed with respect to equations 2-7. FIG. 3A1 is a flowchart illustrating an example method 324 to determine if the hypothesis H1 of method 300 of FIG. 3A is validated, in accordance with some embodiments of the present disclosure. Thus, the flow chart of FIG. 3A1 is an example implementation of the block 324 of FIG. 3A.

Referring to FIG. 3A1, at 324a, a mean Euclidean distance D (first group) (first group) among the selected audience members of the first group is determined. The determination of this mean Euclidean distance is discussed in further detail with respect to equations 2 and 3, where the distance D_invited_invited of these equations correspond to the mean Euclidean distance D_(first_group)_(first_group) of block 324a. In some embodiments, the mean Euclidean distance D_(first_group)_(first_group) is determined using the truncated feature vectors, as discussed herein. As further discussed, the mean Euclidean distance D_(first_group)_(first_group) is an indication of similarity strength among the selected audience members of the first group—the lower the mean Euclidean distance D_(first_group)_(first_group), the higher is the similarity strength among the selected audience members of the first group.

At 324b, a mean Euclidean distance D_(first_group)_(second_group) between the selected audience members of the first group and the nonselected audience members of the second group is determined. In some embodiments, the mean Euclidean distance D_(first_group)_(second_group) is also determined using the truncated feature vectors, as discussed with respect to the Euclidean distance D_(first_group)_(first_group) of block 324a. The determination of this mean Euclidean distance is discussed in further detail with respect to equations 4, 5, and 5a, where the distance D_invited_noninvited of these equations correspond to the mean Euclidean distance D_(first_group)_(second_group) of block 324b. As discussed, the mean Euclidean distance D_(first_group)_(second_group) is an indication of similarity strength between the selected audience members of the first group and the nonselected audience members of the second group—the higher (or larger) the mean Euclidean distance D_(first_group)_(second_group), the lower (or lesser) is the similarity strength between the selected audience members of the first group and the nonselected audience members of the second group

At 324c, a determination is made as to whether D_(first_group)_(first_group)<D_(first_group)_(second_group), with a p-value lower than a threshold, e.g., as discussed with respect to equation 7. In the example of equation 7, the p-value used is 0.025. If “Yes” at 324c, the method 324 proceeds to 324d, where the hypothesis H1 is validated. If “No” at 324c, the method 324 proceeds to 324e, where the hypothesis H1 is not validated.

If the hypothesis H1 is not validated in 324, this implies that the feature selection at block 312 may not have been optimal or near optimal. As a result, the selected audiences in the first group A1 is not dissimilar enough with respect to the non-selected audiences in the second group B1. Thus, referring again to FIG. 3A, if the hypothesis H1 is not validated in 324 (i.e., “No” at 324), the method 300 loops back to block 312 of the method 300, where a different subset of the N features are selected.

For example, as previously discussed herein, during the first iteration of the block 312, the selected subset of N was given by N1. During the second iteration of the block 312, the selected subset of the N features is represented by N2. One or more features in feature subset N2 is different from the features in feature subset N1. Thus, feature subsets N1 and N2 can partially overlap, but not fully overlap.

Merely as an example, the subset of features N1 during the first iteration of the block 312 can be {fa, fc, fd, fe, fg}. In contrast, the subset of features N2 during the second iteration of the block 312 can be {fa, fc, fd, fe, fh}. Thus, the feature fg is replaced with feature fh in the subset of features N2. In another example, the subset of features N2 during the second iteration of the block 312 can be {fa, fb, fd, fe, fh}, where two features are replaced in the feature subset N1 to generate N2. In some embodiments, the subsets N1 and N2 are selected by the feature vector module 108, based on input received from the marketer.

Also during the second iteration of block 312, the model generation module 120 generates another model, such as a similarity graph, illustrated in FIG. 4C. The similarity graph of FIG. 4C is generated based on the subset N2 of features. Accordingly, the similarity graph of FIG. 4C is different from the similarity graph of FIG. 4B, which was generated during the first iteration of the block 312 based on the subset N1 of features. For example, placement of various audience members, as well as distances between any pair of audience members, are different in the two similarity graphs, as the two graphs were respectively developed using two different subset of features.

During the second iteration of the method 300, the method 300 then proceeds from 312 to 316, where the system 102 (such as the member selection module 104) refines the first group of selected audience members and the second group of non-selected audience members, based on the truncated feature vectors calculated using the new subset of features. FIG. 4C illustrates the refined first group A2 of selected audience members and the second group B2 of non-selected audience members.

Thus, as discussed, during the first iteration of the method 300, the first group A1 of selected audience members comprises audience members M1, M3, M4, and M9, as illustrated in FIG. 4B. In contrast, during the second iteration of the method 300, the first group A2 of selected audience members comprises audience members M4, M5, M6, M8, M9, and M12, as illustrated in FIG. 4C. Thus, the first group A1 during the first iteration of the method 300 can be different from the first group A2 during the second iteration of the method 300. For example, during the first iteration of the method 300, feature subset N1 was used to select the audience members within the first group A1. On the other hand, during the second iteration of the method 300, feature subset N2 was used to select the audience members within the first group A2. Hence, the first group A1 is different from the first group A2.

During the second iteration of the method 300, the method 300 then proceeds from block 316 to blocks 320 and 324, where the system 102 checks whether the newly selected first group A2 and the non-selected second group B2 validate the hypothesis H1. If the hypothesis H1 is still not validated, the blocks 312, 316, 320, and 324 are repeated iteratively, until the hypothesis H1 is validated.

If the hypothesis H1 is validated, this implies that the audience members within the selected group A2 are look-alike or similar audience members, and audience members between the selected group A2 and the non-selected group B2 are dissimilar or not look-alike audiences. Thus, the systems 102 and/or 202 takes into account the context of the marketing campaign, as well as knowledge learned from past similar marketing campaign, to select a set of relevant attributes or features (e.g., feature subset N2) that will result in contextual similarity among the audience members within the selected group A2. The selection of the set of relevant attributes or features are done iteratively, based on validating the statistical hypothesis testing of hypothesis H1 on a trained model, which is the similarity graphs of FIGS. 4A-4C.

Once the hypothesis H1 is validated (i.e., “Yes” at 324), the method 300 proceeds from block 324 to 328, where the system 102 causes to initiate the marketing campaign using the selected audience members from the first group. Here the first group referred to is the first group that was formed during the last iteration of the block 316. For example, if the blocks 312, . . . , 324 were repeated twice, then the first group of block 328 is the first group A2 of FIG. 4C. Thus, at 328, the marketing campaign is initiated using the selected audience members M4, M5, M6, M8, M9, and M12 from the first group A2. The selected audience members M4, M5, M6, M8, M9, and M12 from the first group A2 are the target audience for the marketing campaign, as the marketer targets this group of selected audience during the marketing campaign.

Thus, in method 300, the model generation module 120 is trained iteratively to generate models, such as similarity graphs, until the hypothesis H1 is validated. For example, during the first iteration, the model generation module 120 is trained to generate the similarity graph of FIGS. 4A and 4B based on the subset N1 of features. Similarly, during the second iteration, the model generation module 120 is trained to generate the similarity graph of FIG. 4C, based on the subset N2 of features. This iterative training of the model generation module 120 continues, until the optimal or near optimal set of features are selected, where the selection of the optimal or near optimal set of features are reflected via validation of the hypothesis H1.

As discussed, the marketer conducts the marketing campaign by, for example, approaching and/or engaging the selected audience members of the first group A2 using an appropriate medium. Merely as examples, the marketer conducts the marketing campaign by approaching and/or engaging the selected audience members of the first group A2 via email, physical letters, brochures or pamphlets, by calling the selected audience members over phone, by displaying notification via an installed application in mobile phones of the selected audience members, by visiting houses and/or offices of the selected audience members, setting up exhibition or booths in selected geographical locations or conferences, advertising in selected print and/or electronic media, conducting advertisements that are specifically targeted for the selected audience members, and/or otherwise approaching the selected audience members of the first group A2.

The method 300 then proceeds from block 328 to block 332, where the system 102 (e.g., the success identification module 116) identifies a first subset A+ of the first group that have responded positively so far, and a second subset A− of the first group that have so far responded negatively or haven't responded yet to the marketing campaign. For example, the marketing campaign can last for a time duration, such as less than 1 month, about 1 month, 3 months, 6 months, or longer, and the identification operations at 332 can be repeated continuously or at periodic interval throughout the lifespan of the marketing campaign.

For example, FIG. 4D illustrates the first subset A+ of the first group comprising audience members M6, M8, M9, and M12, where these members are identified as “α+” to indicate that these members have responded positively so far in the marketing campaign. A measure of positive response can depend on the type of marketing campaign being conducted, and can be implementation specific. For example, if the marketing campaign is to sell a product, a measure of positive response can be an audience member showing interest to buy the product, enquiring about the product, asking further questions about the product, searching a website to learn more about the product, clicking a link in an email to know more about the product, committing to buy the product by depositing an advance for the product, purchasing of the product, and/or taking other actions that indicates that the audience member is at least somewhat interested in the product.

FIG. 4D also illustrates the second subset A− of the first group comprising audience members M4 and M5, where these members are identified as “a-” to indicate that these members have responded negatively or haven't yet responded so far in the marketing campaign. A measure of negative response can likewise depend on the type of marketing campaign being conducted, and can be implementation specific. For example, a measure of negative response can be showing disinterest in buying a product, not enquiring further about the product, deleting or not reading an email about the product, selecting an unsubscribe option to unsubscribe from future emails about the product, and/or otherwise taking other actions that indicates that the audience member is not interested in the product.

In an example, the marketer may not be able to directly influence each and every positive or negative outcome of the marketing campaign. For example, the audience member M4 may be a right type of audience for the marketing campaign to sell a product—but he or she may have bought a similar product in recent past, due to which he or she may have negatively responded to the marketing campaign. Or the audience member M4 may have purchased the same product from a different source, due to which he or she may have negatively responded to the marketing campaign. For example, the feature vector of an α− audience member (e.g., M4) may sufficiently match with the feature vector of an α+ audience member, yet the two audience members can respond differently to the marketing campaign. In such scenarios, it may be difficult to discern any pattern between the two subsets A+ and A− of the first group A2.

However, in some other examples, there may be some pattern or distinguishing factors between the two subsets A+ and A− of the first group A2. Merely as an example, assume a web-based marketplace is conducting a marketing campaign to sell diapers online. The marketer may select features such as whether the audience members have babies who uses diapers, income of the audience members, and/or education level of the audience members. Once the marketing campaign continues, the marketer identifies the two subsets A+ and A− of the first group A2. The marketer may, merely as an example, identify that when both parents work, the audience member is likely to purchase the diapers online—whereas when one parent is a stay-home parent caring for the baby, the audience member is unlikely to purchase the diapers online (e.g., the non-working parent has time to go to a physical store and buy diapers from the physical store). In such an example, there may be clear distinguishing pattern between the two subsets A+ and A− of the first group A2.

The method 300 then proceeds from block 332 to block 336. In some embodiments, the operations of block 336 is optional, and hence, is illustrated using dashed lines. At 336, the system 102 (e.g., the validation module 112) checks to determine whether the first subset A+ and the second subset A− satisfy or otherwise validate a hypothesis H2. In an example, the hypothesis H2 is as follows: The similarity strength within members of subset A+ is greater than the similarity strength between members of subset A+ and members of subset A−.

In testing the hypothesis H2, average or mean Euclidean distance is used as a metric for the similarity strength, as discussed with respect to equation 1, according to some embodiments. Note that as discussed herein previously, the lower the mean Euclidean distance, the higher is the similarity strength. Thus, in essence, hypothesis 2 tests whether a mean inner distance (e.g., mean or average Euclidean distance) between successful leads (i.e., members of subset A+) is smaller than a mean outer distance (e.g., mean or average Euclidean distance) between successful leads (i.e., members of subset A+) and non-successful leads (i.e., members of subset A−).

Note that the Euclidean distances used to test hypothesis 2 are based on the corresponding truncated feature vectors discussed herein, according to some embodiments. In more detail, only those features that are included in the selected subset of features (e.g., selected at last iteration of block 312) are used to calculate the Euclidean distances. For example, if there are N total features, N2 of which are selected during the last iteration of block 312, then the Euclidean distances are calculated using feature vectors comprising the N2 features only.

For instance, referring again to FIG. 4D, audience members M6, M8, M9, and M12 are included in the first subset A+, and audience members M4 and M5 are included in the second subset A−. Accordingly, to validate the hypothesis 2, the mean or average Euclidean distance within members of subset A+ is determined as follows:

D_A+_A+=average of (d6_8, d6_9, d6_12, d8_9, d8_12, and d9_12). Equation 8

Here, for example, d6_8 is calculated using the subset N2 features, as discussed with respect to equation 2a. A more generalized form of this equation can be easily derived from equation 3 discussed herein previously. Furthermore, the mean or average Euclidean distance between members of subset A+ and members of subset A− is determined as follows:

D_A+_A−=average of (d6_4, d6_5, d8_4, d8_5, d9_4, d9_5, d12_4, d12_5). Equation 9

A more generalized form of this equation can be easily derived from equations 5a and 5b discussed herein previously. Finally, a difference between the two distances of equations 8 and 9 are computed as follows:

D2=(D_A+_A+)−(D_A+_A−). Equation 10

The hypothesis H2 is satisfied if D2 is less than 0 with at least a threshold confidence level. The confidence level is a measured using the p-value or probability value, which is commonly used in hypothesis testing.

Thus, the hypothesis H2 is validated if:

D2<0, and

p-value<threshold value (e.g., 0.05 at a 95% level of confidence) Equation 11

Thus, in equation 11, the threshold p-value is 0.05, although another appropriate threshold p-value can also be used. In an example, the hypothesis testing of H2 is a two-tail test and therefore, the similarity is relatively significantly different and contextual with a p-value threshold of 0.05. Thus, for example, the p-value threshold used in equation 11 for validation of hypothesis H2 is higher than the p-value threshold used in equation 7 for validation of hypothesis H1.

In an example, if D2 is greater than 0, this implies that successful audience members α+ do not have relatively strong similarity among themselves. In such a case, one or more additional non-selected audience members from the group B2, who have strong similarity with the successful audience members α+, can be selected for the marketing campaign. Thus, in some embodiments, based on the validation results of the hypothesis H2, the selection of the first group may be fine-tuned, as will be discussed with respect to FIG. 3B in further detail.

FIG. 3B is a flowchart illustrating an example method 350 for expanding a previous selection of target audience members for a marketing campaign, in accordance with some embodiments of the present disclosure. Method 350 can be implemented, for example, using the system architecture illustrated in FIGS. 1 and/or 2, and described herein, e.g., using the systems 102 and/or 202. However other system architectures can be used in other embodiments, as apparent in light of this disclosure. To this end, the correlation of the various functions shown in FIG. 3B to the specific components and functions illustrated in FIGS. 1 and 2 is not intended to imply any structural and/or use limitations. Rather, other embodiments may include, for example, varying degrees of integration wherein multiple functionalities are effectively performed by one system. In another example, multiple functionalities may be effectively performed by more than one system.

At 354 of the method 350, the systems 102 and/or 202 (e.g., the member selection module 104) access (i) a list L of potential audience member population, (ii) a first group of selected audience members, (iii) a second group of non-selected audience members, (iv) a first subset A+ of the first group that have responded positively in the current or a previous marketing campaign, and (v) a second subset A− of the first group that have so far responded negatively or haven't responded yet in the current or a previous marketing campaign.

The list, groups, and the subset of 354 may be from a current campaign that the marketer is currently running, or may be from a previous marketing campaign for a similar product or service that the marketer has previously executed.

For example, in accordance with the method 300 of FIG. 3A, a marketer can access the list L, the first group A2 of selected audience, the second group B2 of selected audience, the first subset A+ that have responded positively in the current marketing campaign so far, and the second subset A− of the first group that have so far responded negatively or haven't responded yet in the current marketing campaign, as discussed with respect to FIGS. 4A-4D. Note that at 328 of the method 300, the marketer has already initiated the current marketing campaign. Using the information obtained so far from the method 300 of FIG. 3A for the current marketing campaign, the marketer can expand the selection of the first group of invited participants in accordance with the method 350 of FIG. 3B, and continue with the campaign.

In another example, assume that the marketer had in the past executed a successful marketing campaign, and wants to execute another new marketing campaign for the same or similar product or service. For example, the previous marketing campaign can be for an older model or version of a product or video game, and the new marketing campaign can be for an updated model or version of the same product or video game. Thus, the marketer can use information obtained from the previous campaign to launch the current campaign. In such an example scenario, the marketer can reuse the list L, the first group A2, the second group B2, and the first subset A+ and second subset A− from the previous marketing campaign for the new marketing campaign. Thus, in such an example, the information referred to at 354 can be from the previous marketing campaign, to be used for expanding the target audience for the current marketing campaign.

The method 300 then proceeds from block 354 to block 358. At 358, the systems 102 and/or 202 (e.g., the member selection module 104) identifies one or more audience members of the second group of non-selected audience members, who have relatively strong similarity to the first subset A+ of the first group. That is, the identified one or more audience members of the second group of non-selected audience members looks like the first subset A+ of the first group, and hence, referred to as “look alike” audience members relative to the members of the first subset A+. For example, referring to FIG. 4E, the audience members M10 and M11 are identified to have relatively strong similarity to one or more α+ members M6, M8, M9, and M12 of the first subset A+ of the first group.

A measure of relatively strong similarity significance, as discussed with respect to block 358, can be implementation specific. For example, to determine the relatively strong similarity of block 358, a first average of distances between a non-selected audience member and members of the subset A+ is determined. Also, a second average of distances between the non-selected audience member and members of the subset A− is determined. Then, if the first average is less than the second average, then the non-selected member is identified to be similar to the subset A+ compared to the subset A−.

For example, for member M11 in the non-selected group B2, the first average is:

D_M11_A+=average of (d11_6, d11_9, d11_8, d11_12) Equation 12

Also, for member M11, the second average is:

D_M11_A−=average of (d11_4, d11_5) Equation 13

Note that the distances referred to in equations 12 and 13 are still the truncated vectors discussed with respect to the method 300. In the example of FIG. 4E, (D_M11_A+) is less than (D_M11_A−). Accordingly, audience member M11 is identified at 358 to have relatively strong similarity relative to the first subset A+ of the first group, compared to the similarity of the audience member M11 to the second subset A− of the first group.

In another example, for member M3, the first average is:

D_M3_A+=average of (d3_6, d3_9, d3_8, d3_12). Equation 14

Also, for member M3, the second average is:

D_M3_A−=average of (d3_4, d3_5) Equation 13

In the example of FIG. 4E, (D_M3_A+) is higher than (D_M3_A−). Accordingly, audience member M11 is identified at 358 to have weak similarity to the first subset A+ of the first group, compared to the similarity of the audience member M11 to the second subset A− of the first group. Thus, the member M3 is not identified at 358 of the method 350.

The method 300 then proceeds from block 358 to block 362. At 362, the systems 102 and/or 202 (e.g., the member selection module 104) revises the first group A2 to include the one or more audience members identified at 358. For example, as illustrated in FIG. 4F, the identified members M10 and M11 are now included in the first group A2. Note that the newly included members haven't yet been identified either as α+ or as α−.

The method 300 then proceeds from block 362 to block 366, where the system 102 causes to initiate or continue the marketing campaign using the revised first group. For example, if the information at block 354 was obtained from a previous campaign, then at 366 the new marketing campaign is initiated. In such a case, the marketer targets the audience members of the revised first group, and initiates the campaign, as discussed with respect to block 328 of the method 300.

On the other hand, if the information at block 354 was obtained from an earlier phase of the marketing campaign (e.g., as discussed with respect to the method 300 of FIG. 3A), then at 366 the same marketing campaign is continued. For example, the marketer targets the newly added audience members (e.g., M10 and M11 of FIG. 4F) of the revised first group, and continues the campaign, as discussed with respect to block 328 of the method 300.

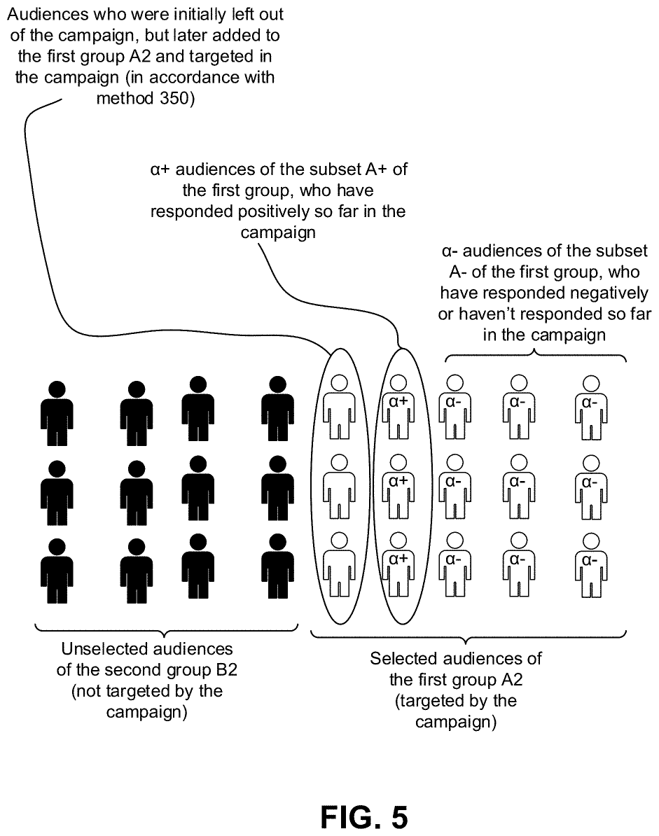

FIG. 5 schematically illustrates example groups of targeted and non-targeted audience members of a marketing campaign, in accordance with some embodiments of the present disclosure. For example, FIG. 5 illustrates unselected audiences of the second group B2, who are not targeted by the marketing campaign. Examples of such audience members include M1, M2, M3, and M7 of FIG. 4F.

For example, FIG. 5 also illustrates selected audiences of the first group A2, who are targeted by the marketing campaign. As discussed herein, the first group A2 includes new audience members who were initially left out of the campaign, but later added from the second group B2 to the first group A2 and targeted in the campaign, as discussed with respect to method 350 of FIG. 3B. Examples of such newly added audience members include M10 and M11 discussed with respect to of FIGS. 4E and 4F.

The first group A2 also includes α+ audience members of the subset A+ of the first group, who have responded positively so far in the campaign. Examples of such α+ audience members include M6, M8, M9, and M12 discussed with respect to of FIGS. 4D, 4E and 4F.

The first group A2 also includes α− audience members of the subset A− of the first group, who have responded negatively or have not responded so far in the campaign. Examples of such α− audience members include M4 and M5 discussed with respect to of FIGS. 4D, 4E and 4F.

Numerous variations and configurations will be apparent in light of this disclosure and the following examples.

Example 1. A method for selecting audiences for a marketing campaign, the method comprising: (a) accessing a list of potential audience members, wherein each potential audience member is associated with a corresponding feature vector comprising corresponding values of a plurality of features; (b) selecting a subset of features from the plurality of features; (c) based on the subset of features, selecting a first group of audience members from the list for inclusion in the marketing campaign, thereby also defining a second group of audience members from the list for exclusion from the marketing campaign; (d) determining a first mean Euclidean distance indicative of a first similarity among the audience members in the first group, based on the subset of features associated with the audience members in the first group; (e) determining a second mean Euclidean distance indicative of a second similarity between the audience members in the first group and audience members in the second group, based on the subset of features associated with the audience members in the first and second groups; (f) in response to the first similarity being equal to or lower than the second similarity, (i) updating the subset of features the plurality of features, and (ii) iteratively repeating (c), (d), and (e), until the first similarity is higher than the second similarity; and (g) causing initiation of the marketing campaign targeting the selected first group of audience members.

Example 2. The method of example 1, wherein updating the subset of features of the plurality of features comprises one or both of: adding a first feature to the subset of features; and/or removing a second feature from the subset of features.

Example 3. The method of any of examples 1-2, further comprising: identifying (i) a first subset of the first group of audience members that have responded positively to the marketing campaign, and (ii) a second subset of the first group of audience members that have not yet responded positively to the marketing campaign; identifying a first audience member in the second group of audience members, such that a similarity strength between the first audience member and one or more members within the first subset of the first group is higher than a similarity strength between the first audience member and one or more members within the second subset of the first group; and removing the first audience member from the second group, and adding the first audience member to the first group.

Example 4. The method of example 3, further comprising: determining the similarity strength between the first audience member and the one or more audience members within the first subset of the first group by calculating a mean Euclidean distance between the feature vector associated with the first audience member and one or more feature vectors associated with the corresponding one or more audience members within the first subset of the first group; and determining the similarity strength between the first audience member and the one or more audience members within the second subset of the first group by calculating another mean Euclidean distance between the feature vector associated with the first audience member and another one or more feature vectors associated with the corresponding one or more audience members within the second subset of the first group.

Example 5. The method of example 1, further comprising: identifying (i) a first subset of the first group of audience members that have responded positively to the marketing campaign, and (ii) a second subset of the first group of audience members that have not yet responded positively to the marketing campaign; determining a third mean Euclidean distance indicative of similarity among the audience members in the first subset; determining a fourth mean Euclidean distance indicative of similarity between the audience members in the first subset and audience members in the second subset; and in response to the third mean Euclidean distance being larger than the fourth mean Euclidean distance, updating the first group by moving one or more audience members from the second group to the first group.

Example 6. The method of any of examples 1-5, wherein determining the first mean Euclidean distance comprises: identifying a plurality of pairs of audience members in the first group; for each pair, determining a corresponding Euclidean distance between a first feature vector associated with one audience member of the pair and a second feature vector associated with another audience member of the pair, such that a plurality of Euclidean distances is determined corresponding to the plurality of pairs; and determining the first mean Euclidean distance by averaging the plurality of Euclidean distances.

Example 7. The method of example 6, wherein each of the first and second feature vectors is a truncated feature vector that includes features that are in the subset of features, and excludes one or more features of the plurality of features that are not in the subset of features.

Example 8. The method of any of examples 1-7, wherein iteratively repeating (c), (d), and (e) comprises: iteratively repeating (c), (d), and (e) until the first mean Euclidean distance is smaller than the second mean Euclidean distance by a threshold confidence level.

Example 9. The method of any of examples 1-8, wherein determining the second mean Euclidean distance comprises: identifying a plurality of pairs of audience members, each pair comprising an audience member from the first group and an audience member from the second group; for each pair, determining a corresponding Euclidean distance between a first truncated feature vector associated with one audience member of the pair and a second truncated feature vector associated with another audience member of the pair, wherein a plurality of Euclidean distances is determined corresponding to the plurality of pairs; and determining the second mean Euclidean distance by averaging the plurality of Euclidean distances.

Example 10. The method of any of examples 1-9, wherein the plurality of features comprises at least one of: one or more demographic features associated with demography of an audience member; one or more firmographic features associated with a work place of the audience member; and/or one or more behavioral features associated with an observed behavior of the audience member.

Example 11. The method of any of examples 1-10, wherein selecting a first group of audience members comprises: generating a similarity graph comprising the potential audience members, based on the subset of features from the plurality of features; and selecting the first group of audience members from the list, based on the similarity graph.

Example 12. A system for selecting audience members for a marketing campaign, comprising: a memory; one or more processors; and an audience selection system executable by the one or more processors to access a list of potential audience members, wherein each potential audience member is associated with a corresponding feature vector comprising corresponding values of one or more features, identify, within the list, a first group and a second group of audience members, wherein there is no overlap between the first and second groups, cause initiation of the marketing campaign with the first group of audience members, without including the second group in the marketing campaign, identify (i) a first subset of the first group of audience members that have responded positively to the marketing campaign, and (ii) a second subset of the first group of audience members that have not yet responded positively to the marketing campaign, identify a first audience member in the second group of audience members, such that a similarity strength between the first audience member and one or more audience members within the first subset is higher than a similarity strength between the first audience member and one or more audience members within the second subset, the similarity strength based on a feature vector associated with the first audience member, update the first group to include the first audience member, and cause to continue the marketing campaign with the updated first group.

Example 13. The system of example 12, wherein the audience selection system is to: determine the similarity strength between the first audience member and the one or more members within the first subset by calculating a mean Euclidean distance between the feature vector of the first audience member and one or more feature vectors associated with the corresponding one or more audience members within the first subset; and determine the similarity strength between the first audience member and the one or more members within the second subset by calculating another mean Euclidean distance between the feature vector of the first audience member and another one or more feature vectors associated with the corresponding one or more audience members within the second subset.

Example 14. The system of example 13, wherein to calculate the mean Euclidean distance, the audience selection system is to: determine a first Euclidean distance between the feature vector of the first audience member and a feature vector associated with a first member of the first subset; determine a second Euclidean distance between the feature vector of the first audience member and a feature vector associated with a second member of the first subset; determine a third Euclidean distance between the feature vector of the first audience member and a feature vector associated with a third member of the first subset; and calculate the mean Euclidean distance, based at least in part on the first, second, and third feature vectors.

Example 15. The system of any of examples 13-14, wherein the similarity strength between the first audience member and the one or more members within the first subset is inversely proportional to the mean Euclidean distance.

Example 16. The system of any of examples 13-15, wherein: the feature vector associated with the first audience member is a truncated version of an original feature vector associated with the first audience member; the original feature vector includes a plurality of features associated with the first audience member; and the truncated version includes a subset of the plurality of features, and not each the plurality of features, associated with the first audience member.

Example 17. The system of any of examples 12-16, wherein the audience selection system is to identify the first audience member in the second group of audience members in response to: determining that a similarity strength among audience members in the first subset is less than a similarity strength between audience members in the first subset and audience members in the second subset.

Example 18. A computer program product including one or more non-transitory machine-readable mediums encoded with instructions that when executed by one or more processors cause a process to be carried out for selecting audiences for a marketing campaign, the process comprising: accessing a list of potential audience members; identifying, within the list, (i) a first group of target audience members for the marketing campaign, and (ii) a second group of non-targeted audience members; identifying (i) a first subset of the first group of audience members who have responded positively so far to the marketing campaign, and (ii) a second subset of the first group of audience members who have not yet responded positively so far to the marketing campaign; determining that a first similarity strength among audience members in the first subset is less than a second similarity strength between audience members in the first subset and audience members in the second subset; and in response to determining that the first similarity strength is less than the second similarity strength, updating the first group to include an audience member from the second group, wherein the marketing campaign is to target the updated first group of audience members.

Example 19. The computer program product of example 18, the process comprising: identifying the audience member in the second group of audience members, such that a similarity strength between the audience member and one or more audience members within the first subset is higher than a similarity strength between the audience member and one or more audience members within the second subset.

Example 20. The computer program product of any of examples 18-19, the process comprising: assigning, to each potential audience member in the list, a corresponding feature vector comprising corresponding values of a plurality of features; wherein the first and second groups of audience members are identified based at least in part on the feature vectors.

The foregoing detailed description has been presented for illustration. It is not intended to be exhaustive or to limit the disclosure to the precise form described. Many modifications and variations are possible in light of this disclosure. Therefore, it is intended that the scope of this application be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method for selecting audiences for a marketing campaign, the method comprising:
(a) accessing a list of potential audience members, wherein each potential audience member is associated with a corresponding feature vector comprising corresponding values of a plurality of features;
(b) selecting a subset of features from the plurality of features;
(c) based on the subset of features, selecting a first group of audience members from the list for inclusion in the marketing campaign, thereby also defining a second group of audience members from the list for exclusion from the marketing campaign;
(d) determining a first mean Euclidean distance indicative of a first similarity among the audience members in the first group, based on the subset of features associated with the audience members in the first group;
(e) determining a second mean Euclidean distance indicative of a second similarity between the audience members in the first group and audience members in the second group, based on the subset of features associated with the audience members in the first and second groups;
(f) in response to the first similarity being equal to or lower than the second similarity, (i) updating the subset of features the plurality of features, and (ii) iteratively repeating (c), (d), and (e), until the first similarity is higher than the second similarity; and
(g) causing initiation of the marketing campaign targeting the selected first group of audience members.

2. The method of claim 1, wherein updating the subset of features of the plurality of features comprises one or both of:
adding a first feature to the subset of features; and/or
removing a second feature from the subset of features.

3. The method of claim 1, further comprising:
identifying (i) a first subset of the first group of audience members that have responded positively to the marketing campaign, and (ii) a second subset of the first group of audience members that have not yet responded positively to the marketing campaign;
identifying a first audience member in the second group of audience members, such that a similarity strength between the first audience member and one or more members within the first subset of the first group is higher than a similarity strength between the first audience member and one or more members within the second subset of the first group; and
removing the first audience member from the second group, and adding the first audience member to the first group.

4. The method of claim 3, further comprising:
determining the similarity strength between the first audience member and the one or more audience members within the first subset of the first group by calculating a mean Euclidean distance between the feature vector associated with the first audience member and one or more feature vectors associated with the corresponding one or more audience members within the first subset of the first group; and
determining the similarity strength between the first audience member and the one or more audience members within the second subset of the first group by calculating another mean Euclidean distance between the feature vector associated with the first audience member and another one or more feature vectors associated with the corresponding one or more audience members within the second subset of the first group.

5. The method of claim 1, further comprising:
identifying (i) a first subset of the first group of audience members that have responded positively to the marketing campaign, and (ii) a second subset of the first group of audience members that have not yet responded positively to the marketing campaign;
determining a third mean Euclidean distance indicative of similarity among the audience members in the first subset;
determining a fourth mean Euclidean distance indicative of similarity between the audience members in the first subset and audience members in the second subset; and
in response to the third mean Euclidean distance being larger than the fourth mean Euclidean distance, updating the first group by moving one or more audience members from the second group to the first group.

6. The method of claim 1, wherein determining the first mean Euclidean distance comprises:
identifying a plurality of pairs of audience members in the first group;
for each pair, determining a corresponding Euclidean distance between a first feature vector associated with one audience member of the pair and a second feature vector associated with another audience member of the pair, such that a plurality of Euclidean distances is determined corresponding to the plurality of pairs; and
determining the first mean Euclidean distance by averaging the plurality of Euclidean distances.

7. The method of claim 6, wherein each of the first and second feature vectors is a truncated feature vector that includes features that are in the subset of features, and excludes one or more features of the plurality of features that are not in the subset of features.

8. The method of claim 1, wherein iteratively repeating (c), (d), and (e) comprises:
iteratively repeating (c), (d), and (e) until the first mean Euclidean distance is smaller than the second mean Euclidean distance by a threshold confidence level.

9. The method of claim 1, wherein determining the second mean Euclidean distance comprises:
identifying a plurality of pairs of audience members, each pair comprising an audience member from the first group and an audience member from the second group;
for each pair, determining a corresponding Euclidean distance between a first truncated feature vector associated with one audience member of the pair and a second truncated feature vector associated with another audience member of the pair, wherein a plurality of Euclidean distances is determined corresponding to the plurality of pairs; and
determining the second mean Euclidean distance by averaging the plurality of Euclidean distances.

10. The method of claim 1, wherein the plurality of features comprises at least one of:
one or more demographic features associated with demography of an audience member;
one or more firmographic features associated with a work place of the audience member; and/or
one or more behavioral features associated with an observed behavior of the audience member.

11. The method of claim 1, wherein selecting a first group of audience members comprises:
generating a similarity graph comprising the potential audience members, based on the subset of features from the plurality of features; and
selecting the first group of audience members from the list, based on the similarity graph.

12. A system for selecting audience members for a marketing campaign, comprising:
a memory;
one or more processors; and
an audience selection system executable by the one or more processors to
access a list of potential audience members, wherein each potential audience member is associated with a corresponding feature vector comprising corresponding values of one or more features,
identify, within the list, a first group and a second group of audience members, wherein there is no overlap between the first and second groups,
cause initiation of the marketing campaign with the first group of audience members, without including the second group in the marketing campaign,
identify (i) a first subset of the first group of audience members that have responded positively to the marketing campaign, and (ii) a second subset of the first group of audience members that have not yet responded positively to the marketing campaign,
identify a first audience member in the second group of audience members, such that a similarity strength between the first audience member and one or more audience members within the first subset is higher than a similarity strength between the first audience member and one or more audience members within the second subset, the similarity strength based on a feature vector associated with the first audience member,
update the first group to include the first audience member, and
cause to continue the marketing campaign with the updated first group.

13. The system of claim 12, wherein the audience selection system is to:
determine the similarity strength between the first audience member and the one or more members within the first subset by calculating a mean Euclidean distance between the feature vector of the first audience member and one or more feature vectors associated with the corresponding one or more audience members within the first subset; and
determine the similarity strength between the first audience member and the one or more members within the second subset by calculating another mean Euclidean distance between the feature vector of the first audience member and another one or more feature vectors associated with the corresponding one or more audience members within the second subset.

14. The system of claim 13, wherein to calculate the mean Euclidean distance, the audience selection system is to:
determine a first Euclidean distance between the feature vector of the first audience member and a feature vector associated with a first member of the first subset;
determine a second Euclidean distance between the feature vector of the first audience member and a feature vector associated with a second member of the first subset;
determine a third Euclidean distance between the feature vector of the first audience member and a feature vector associated with a third member of the first subset; and
calculate the mean Euclidean distance, based at least in part on the first, second, and third feature vectors.

15. The system of claim 13, wherein the similarity strength between the first audience member and the one or more members within the first subset is inversely proportional to the mean Euclidean distance.

16. The system of claim 13, wherein:
the feature vector associated with the first audience member is a truncated version of an original feature vector associated with the first audience member;
the original feature vector includes a plurality of features associated with the first audience member; and
the truncated version includes a subset of the plurality of features, and not each the plurality of features, associated with the first audience member.

17. The system of claim 12, wherein the audience selection system is to identify the first audience member in the second group of audience members in response to:
determining that a similarity strength among audience members in the first subset is less than a similarity strength between audience members in the first subset and audience members in the second subset.

18. A computer program product including one or more non-transitory machine-readable mediums encoded with instructions that when executed by one or more processors cause a process to be carried out for selecting audiences for a marketing campaign, the process comprising:
accessing a list of potential audience members;
identifying, within the list, (i) a first group of target audience members for the marketing campaign, and (ii) a second group of non-targeted audience members;
identifying (i) a first subset of the first group of audience members who have responded positively so far to the marketing campaign, and (ii) a second subset of the first group of audience members who have not yet responded positively so far to the marketing campaign;
determining that a first similarity strength among audience members in the first subset is less than a second similarity strength between audience members in the first subset and audience members in the second subset; and
in response to determining that the first similarity strength is less than the second similarity strength, updating the first group to include an audience member from the second group, wherein the marketing campaign is to target the updated first group of audience members.

19. The computer program product of claim 18, the process comprising:
identifying the audience member in the second group of audience members, such that a similarity strength between the audience member and one or more audience members within the first subset is higher than a similarity strength between the audience member and one or more audience members within the second subset.

20. The computer program product of claim 18, the process comprising:
assigning, to each potential audience member in the list, a corresponding feature vector comprising corresponding values of a plurality of features;
wherein the first and second groups of audience members are identified based at least in part on the feature vectors.
